(19) United States
(12) Patent Application Publication
(10) Pub. No.: US 2005/0114172 A1
(43) Pub. Date: May 26, 2005

(54) Network hospital is made as per all individuality diseases, on which one can choose corresponding commercial way for combined diet invigorating substances

(76) Inventors: Jiao Gong, Arcadia, CA (US); Wei Jiang, Arcadia, CA (US)

Correspondence Address: JIAO GONG, 411 S. 3RD AVE #B, ARCADIA, CA, 91006, US

(21) Appl. No.: 10/714,425

(22) Filed: Nov. 17, 2003

(51) Int. Cl. G06F 17/60

(52) U.S. Cl. 705/2

(57) ABSTRACT

My invention is an innovation of commercial method. Characterized by the excellent combination of the intelligent specialty technology of American medicine with the intelligent commercial transaction, it realizes the integration and innovation of indirect e-commerce with direct e-commerce. It creates the integration of virtual doctor, virtual hospital, virtual enterprise and virtual shop. It meets the requirements of personal health in the course of one to one diagnosis (network doctor to consumer). The patent includes the configuration of e-business Website, page layout of browser, joining the membership, downloading the health consult software of network doctor to the terminal computer free of charge, upgrading the software free of charge, remote registration of website, usage of health diagnosis database software of network hospital, confirmation of diseases, confirmation of type of individual cases and principle of cure, glancing over commodities, confirmation of commodities and putting them into shopping vehicle, issuing order of goods, settlement and payment, transport, usage of commodities and feedback of information.

### BACKGROUND OF THE INVENTION

“A network hospital is made as per all individual diseases, on which one can choose corresponding commercial way for combined diet invigorating substances.” Is a commercial method of innovative e-commerce. The most discrepancy and the biggest difference between the patent and the conventional e-commerce is that it innovatively takes technical intelligence of medicine as the crucial technology of commercial method and takes full utilization of the software of network doctor and the software of network hospital to design an integrated plan based on the commercial method of innovative e-commerce to help enterprises to have a large quantity of new customers besides that commodities can be safely bought from the network through the application of e-commerce and process of integration to realize the intelligence of transaction. And it can cater for the requirement of intelligent and individual health service of medicine specialty when electronic transaction is made. It ensures that the transaction by the consumers is safe, the health information and the diagnosis are scientific and precise. Their privacy can be fully protected while they buy commodities on the premise that they fully enjoy health consult free of charge.

According to State Street Bank & Trust Co. V. Signature Financial Group Inc. 149 F.3d, 1368 47 V S. P. O. zd 1596 (Fedcir 1998), it is concluded by the Federal Circuit Court of Appeal that generally, commercial method may constitute the subject of patent. The court has shifted the key point of getting qualification of patent into practical application. It acknowledges that the key of the commercial method is to judge whether the invention has only practical and abstract operation or not. The invention must be the practical application in technical field, that is, to obtain useful, concrete and tangible outcome. Because the commercial method of the patent innovates and develops the conventional e-commerce and meets the three characters (useful, concrete and tangible) by Circuit Court of Appeal, it is the innovation of realizable outcome and system.

When the verdict of Dietary Invigorating Substances Law 103-417, 1994 was made, the Congress stressed that the top thing in the States is to improve the health of America people. The importance of nutrition and the benefits from dietary invigorating substances to improve health and prevent from disease have been continuously to be written into scientific and technical documents. When regard to the health and health care, in particular, science study on dietary invigorating substances, it explains to the consumers how they may select health care items. According to the State's statistics, about 50% of 260 m Americans often consume dietary invigorating substances as a way to improve nutrition. The core technology of the patent, that is, the core commodity is innovated and developed based on the stipulations in American Laws.

In 1969, Advanced Research Projects Agency of the Pentagon set up networks for the military purpose, which was gradually developed into Internet. Based on the Internet, the e-commerce network was set up in 1960s and developed in 1990s. Along with the popularization and maturation of maturation of computer application network and credit care, they have provided a solid foundation and key means of the development of e-commerce. The commercial trade activities beyond the Internet did not come into the kingdom of network until 1991. Since then, the e-commerce becomes the hottest issue of the Internet application. It directly faces the consumers through direct network sales, its intelligent mode of transaction is rapidly popularized in the world. In 1998, the number of e-commerce website for business goes up 420,000. Facing with the rapid development of e-commerce, Forrester Company had to adjust its e-commerce turnover to USD 842.7 billions in 2002. Business to customer (B to C) the e-commerce between enterprises and consumers is a direct way for the consumers to participate economic activities via the Internet, which is similar to the retail business of e-commerce coving wide fields enterprises and persons in the world may participate. It has a very good prospect. However, the e-commerce method, which is similar to the e-commerce and the e-commerce of retailers lacks intelligences, in particular, it lacks the intelligences of specialty technology and the innovation and extension to the functions of the Internet. That is just core issue the patent intends to solve.

### BRIEF SUMMARY OF THE INVENTION

The most discrepancy and the biggest difference between the patent and the other e-commerce is that it adds health consults software of network doctor and health diagnose software of network hospital. The causes and the state of illness of the patient can be diagnosed via the software of network doctor based on the specific diseases, symptom and individual type. And then it makes scientific and specific suggestions for cure and for health. The suggestions made by the intelligent doctor are the outcome of intelligence analysis for causes and the state of illness and are not the popular science knowledge about medicine. It is a diagnosis process of disease and health through the way one intelligent network doctor diagnoses one consumer (one-to-one). The process of diagnosis can be viewed at the terminal of computer, having the features of 24-hour service and random access. Consumers may enjoy the health service at home provided by intelligent network doctor free of charge. The health consult software of network doctor is upgraded every year to meet the requirement of consumers on high quality and high science and technology. The health diagnosis software of network hospital developed from software of network doctor is data base system for e-commerce system of network hospital. When consumers downloads and uses the health consult software of network doctor and meets their personal health consult service, they may register e-commerce website of network hospital if they intend to have further diagnosis and to prevent from diseases. During the process of remote register of websites, the health information stored in the floppy disk of the network doctor may be automatically connected with the database of health diagnosis software of network hospital and all your health data will be in your health record file of network hospital membership. Therefore, database of network hospital will carry out a comprehensive analysis of your every interrogation in order to give you more scientific and more accurate health conclusion and outcome. Based on the state of illness you provided and the health consults in the past, the database of network hospital can also put forward a prescription of health invigorating substances or composition of new medicine for your viewing, confirmation and purchase. The prescriptions or composition of new medicine given to you only serve yourself and are the outcome of diagnosis of your health. It is prescribed by the intelligent network doctor as per the procedure after the detail analysis of your disease, symptom, type of illness and principle of cure is made. After software of network doctor and software of network hospital are added to the e-commerce system of network hospital, it realizes the innovation of virtual doctor, virtual hospital, virtual enterprise and virtual shop. It is the extension to the Internet and the intelligent transaction of e-commerce system, it also completes and practices the intelligence of medicine specialty technology. The intelligence of medicine specialty technology combined with intelligence of commercial transaction is the innovation and bouncing development to the conventional e-commerce system.

### BRIEF DESCRIPTION OF THE SEVERAL VIEWS OF THE DRAWINGS TABLE OF CONTENTS

Table 1 Overall view of a network hospital, which is made as per all individual diseases and one can choose corresponding commercial way for combined diet invigorating substances.

Table 2 List of joining network hospital membership and number of membership.

Table 3 Health consult software of network doctor, disease, system, category, principle of cure, suggested structure of number and its dictionary.

Table 4 Numbering structure of health diagnosis software of network hospital (taking Senile cretinism as an example)

Table 5 Corresponding recipe of health invigorating substances for 40 diseases.

Table 6 Corresponding recipe of health invigorating substances for 30 diseases of different category

TABLE 1
Bri f Description of the Several Views of the Drawing
Overall view of a network hospital, which is made as per all individual diseases and
one can choose corresponding commercial way for combined diet invigorating substances

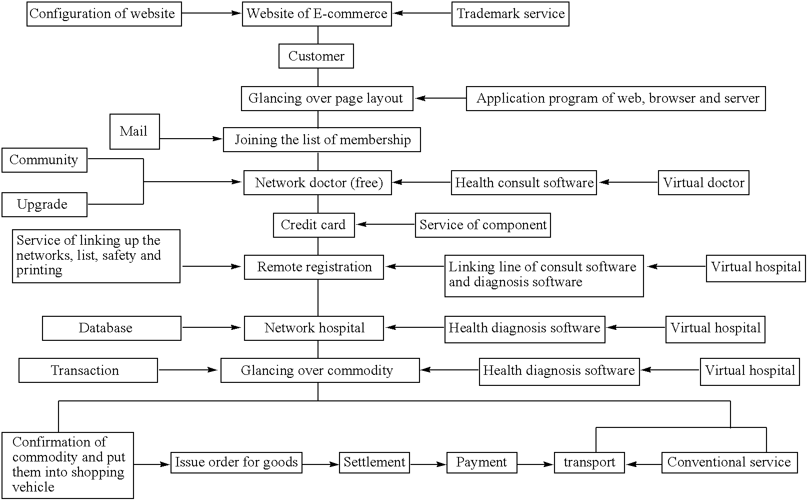

TABLE 2
Brief D cription of the Several View of the Drawing
List of joining network hospital membership and
number of membership

| | |
|---|---|
| E-mail | Real name (fill in as per |
| | standard form) |
| Sex | Date of birth |
| Nationality | Number of passport |
| Telephone | Person to be contacted |
| Fax | Detail address of home and |
| | postal code |
| Name of computer | Password |
| 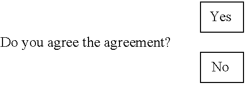 | Determination of membership number |

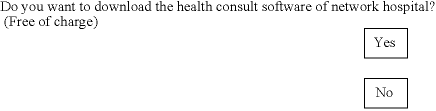

TABLE 3
Health consult software of network doct r, disease, system, category, principle
of cure, suggested structure f number and its dictionary.

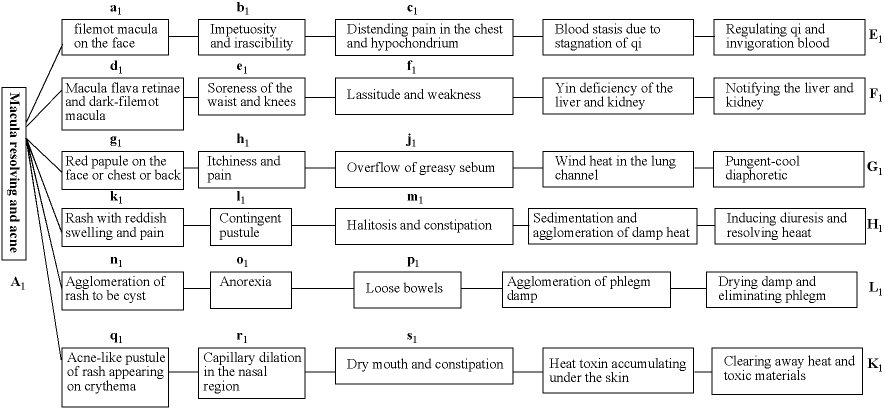

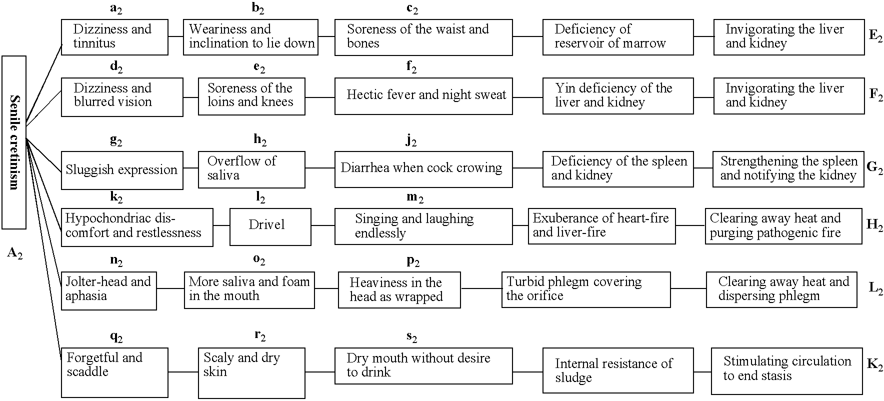

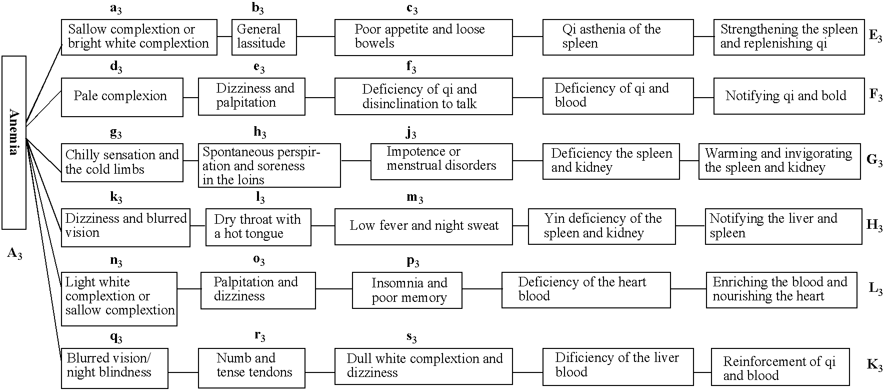

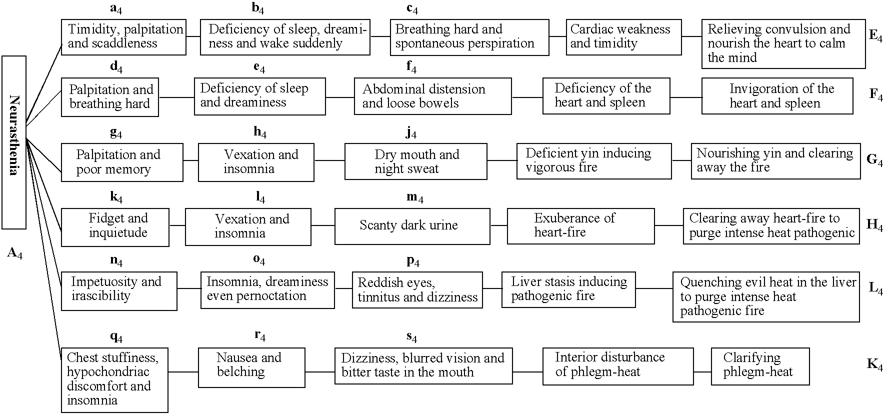

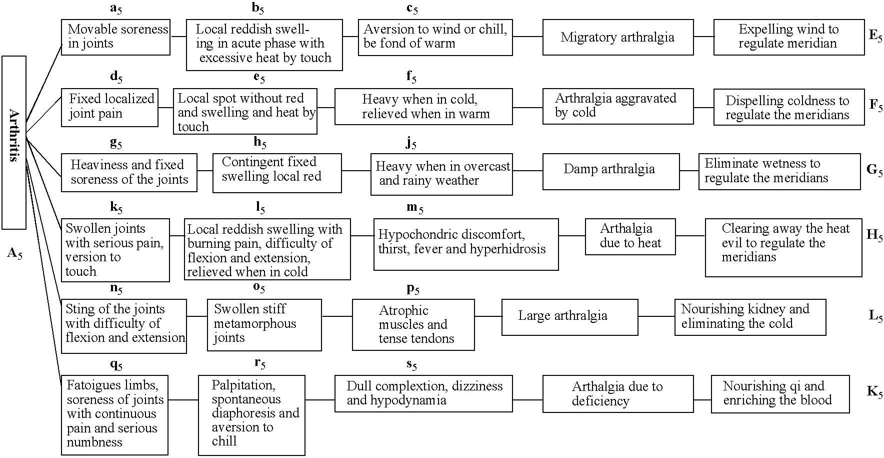

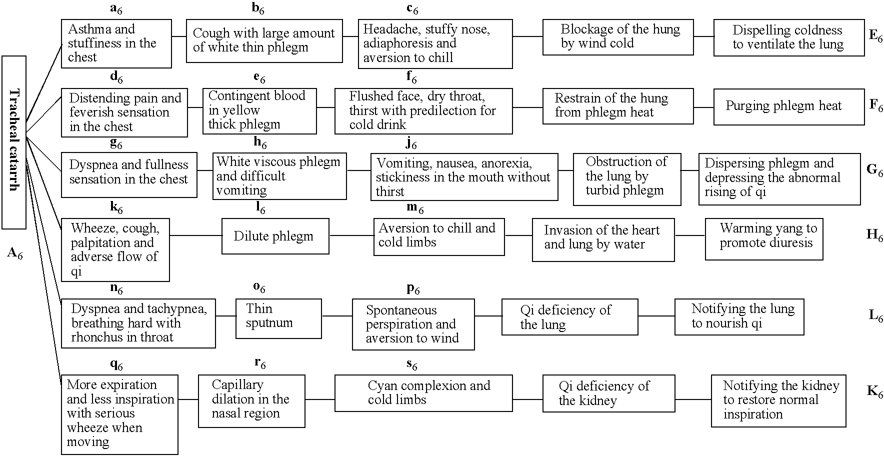

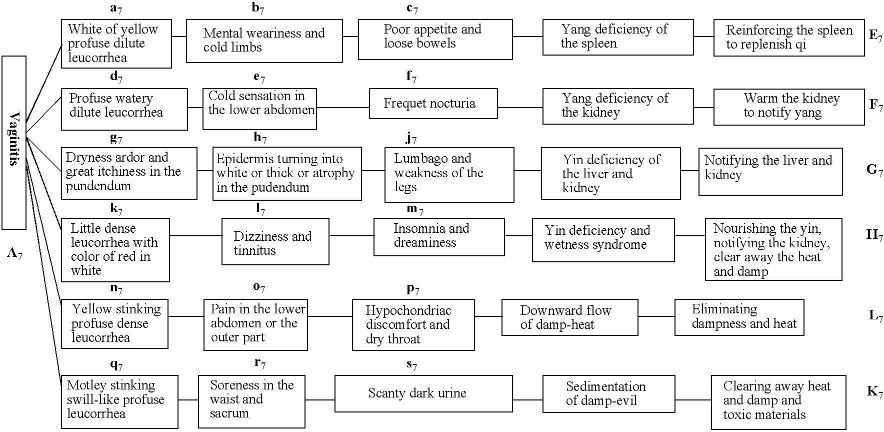

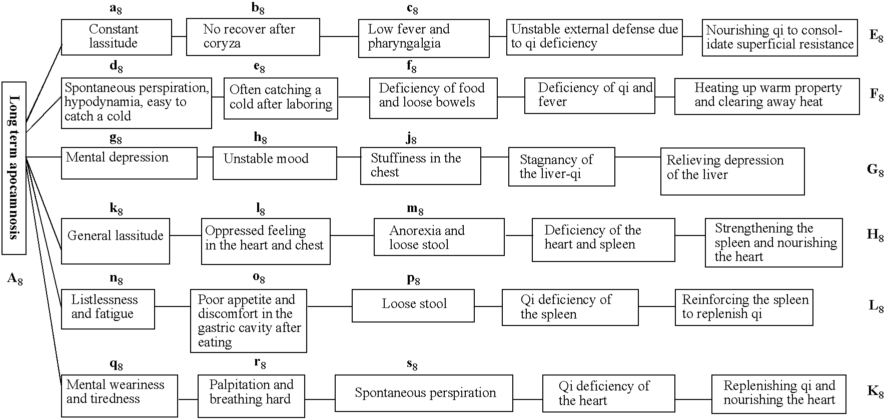

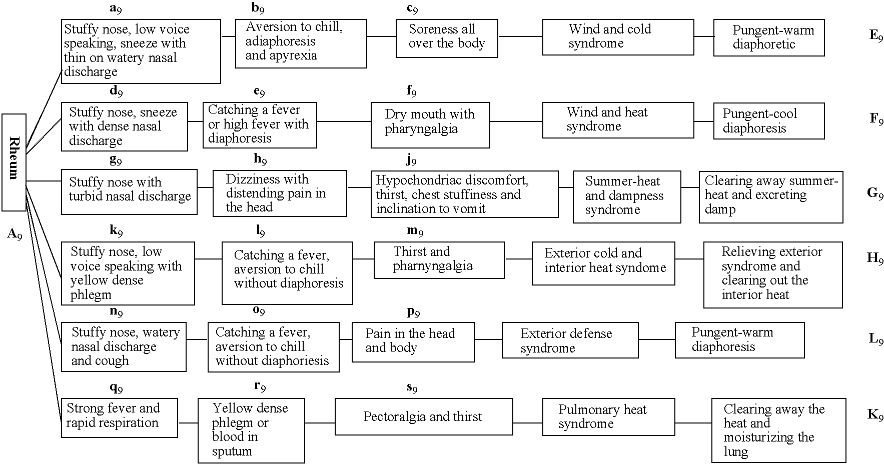

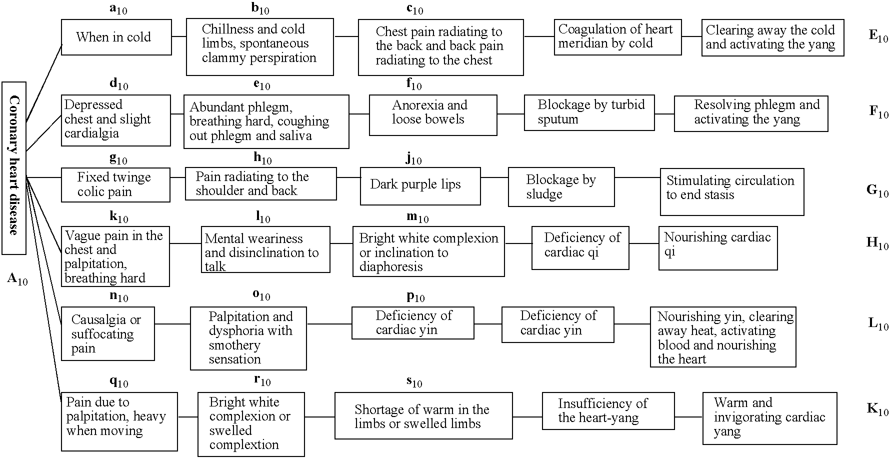

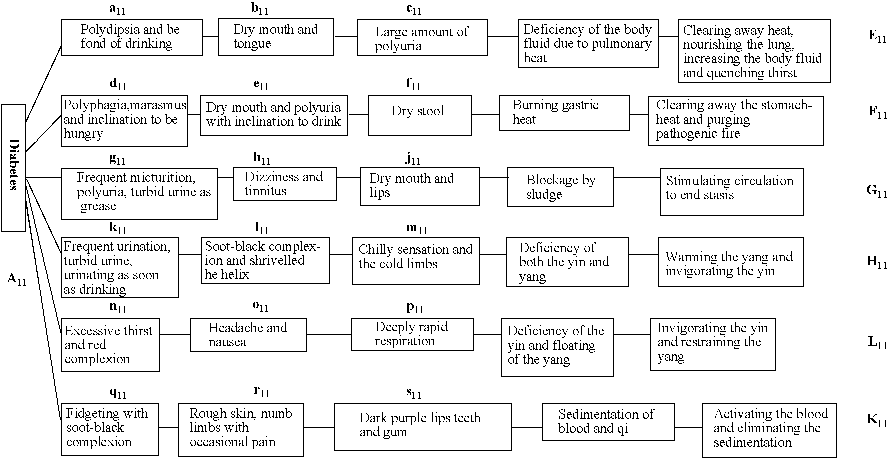

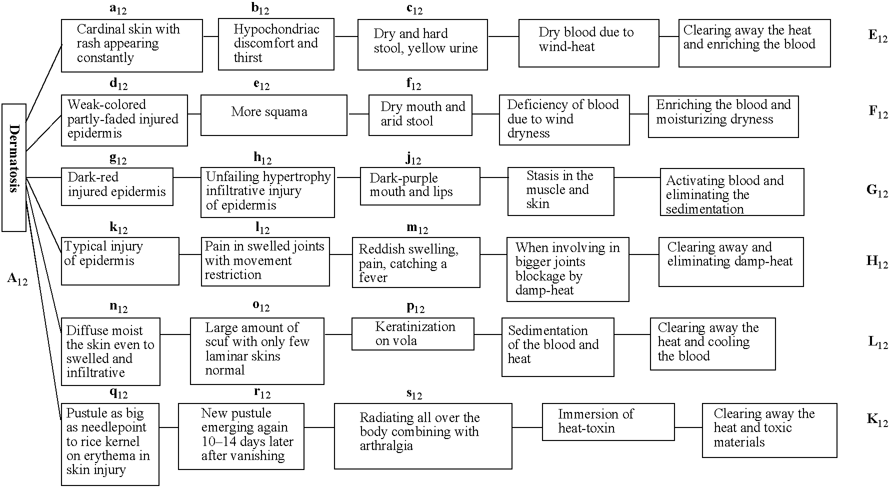

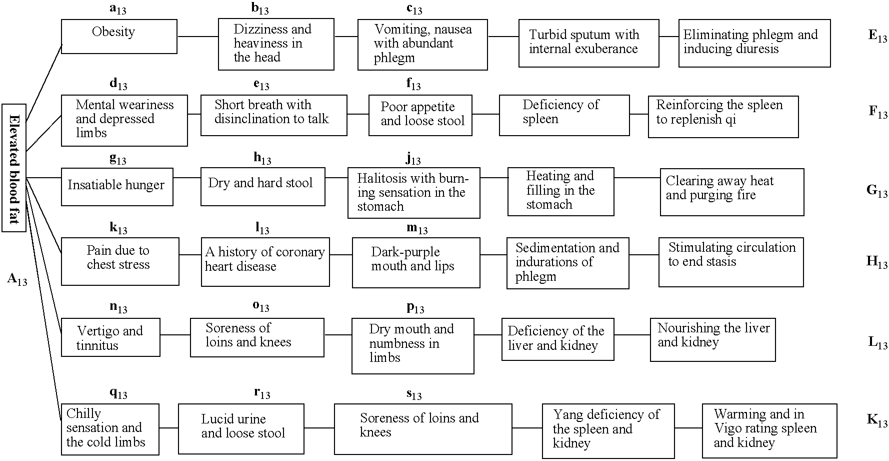

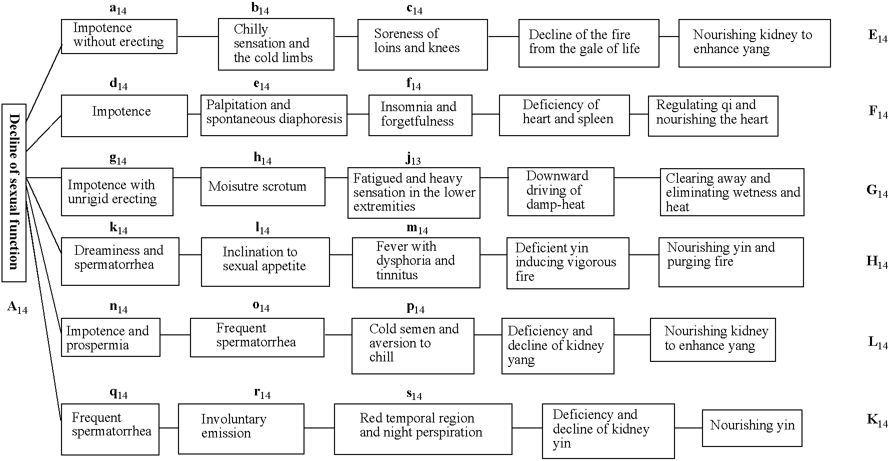

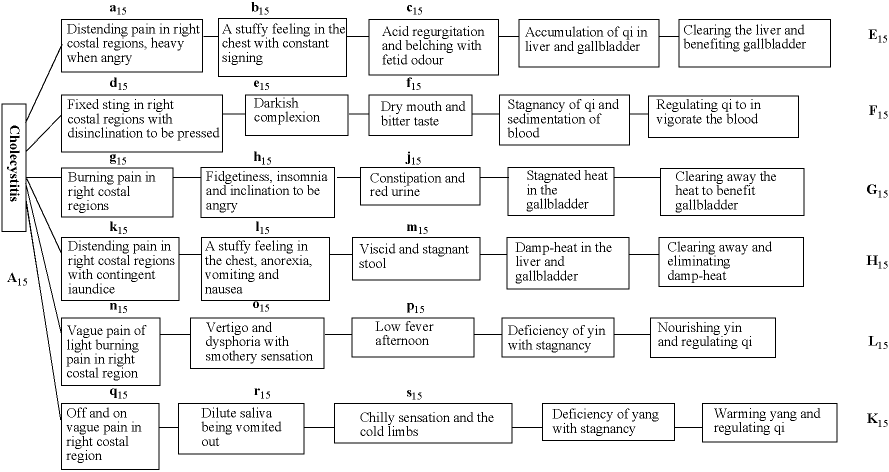

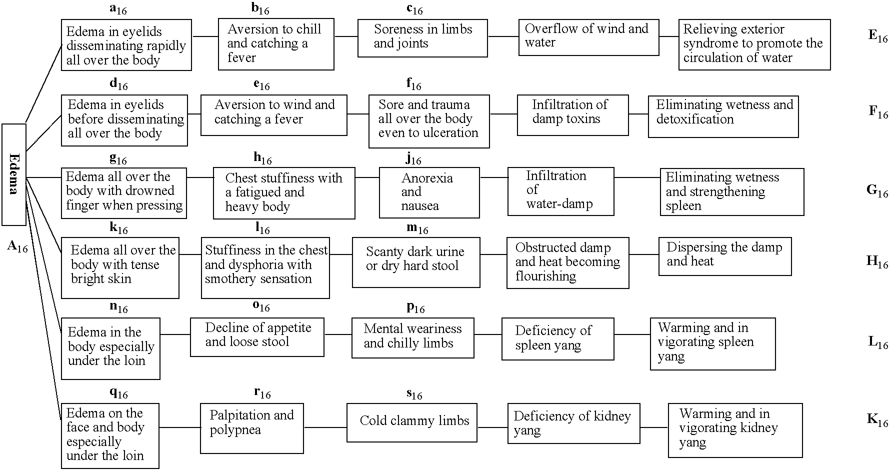

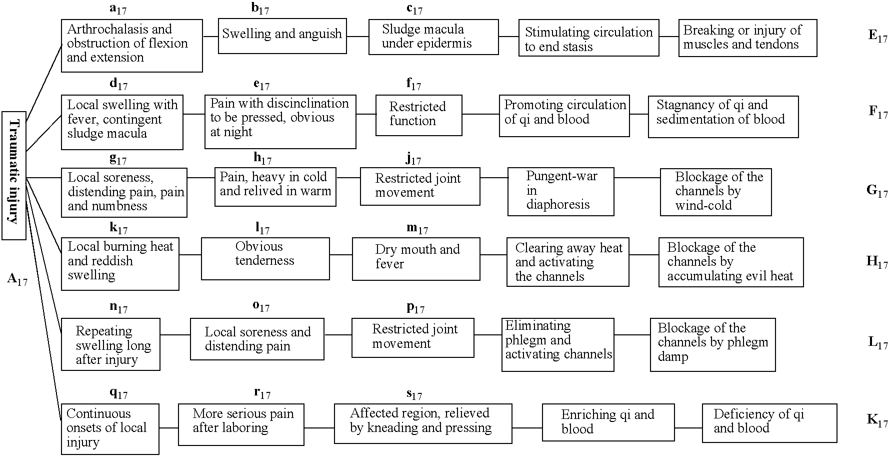

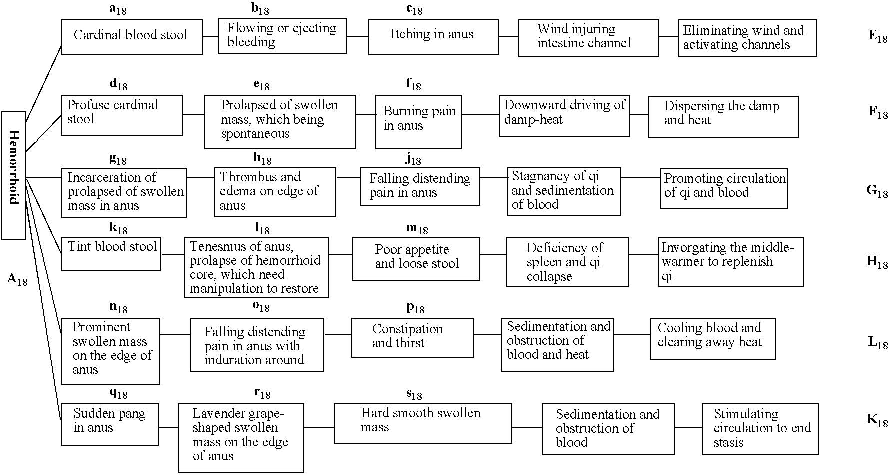

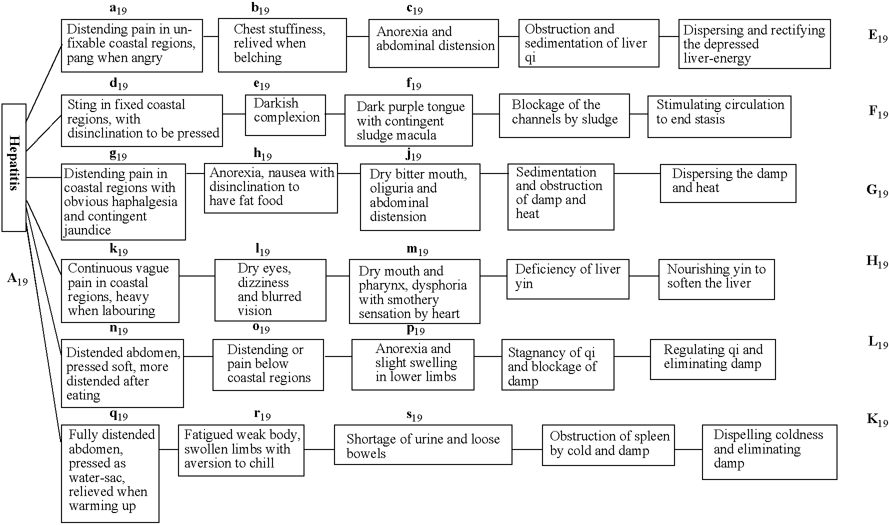

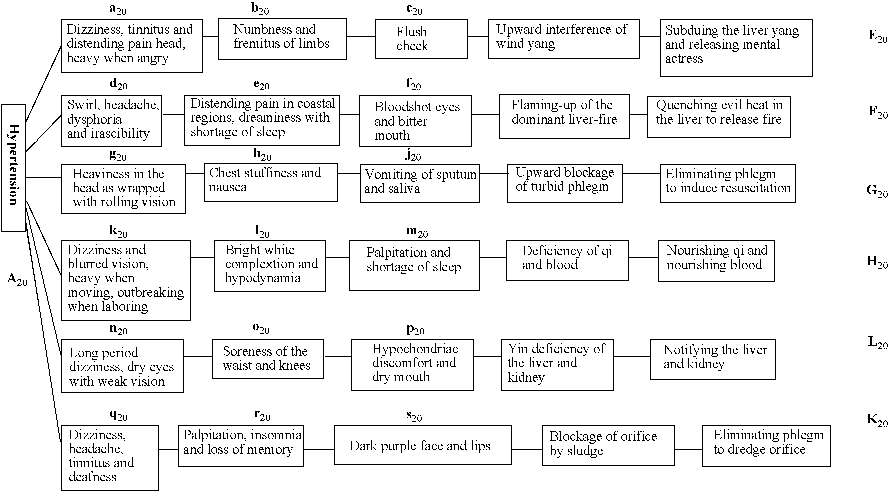

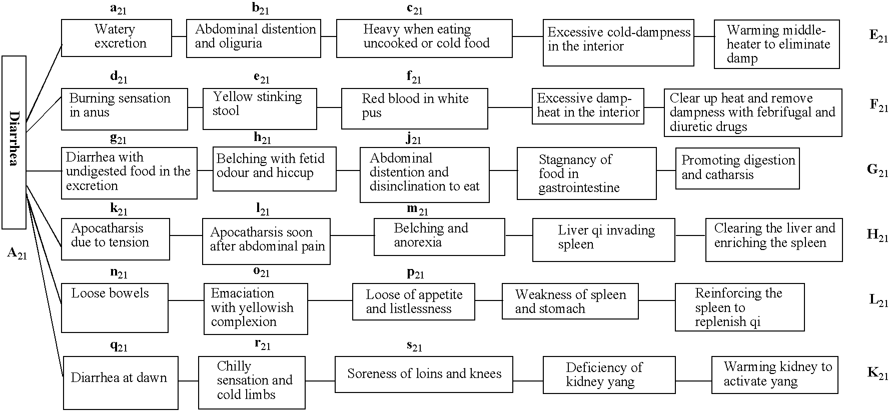

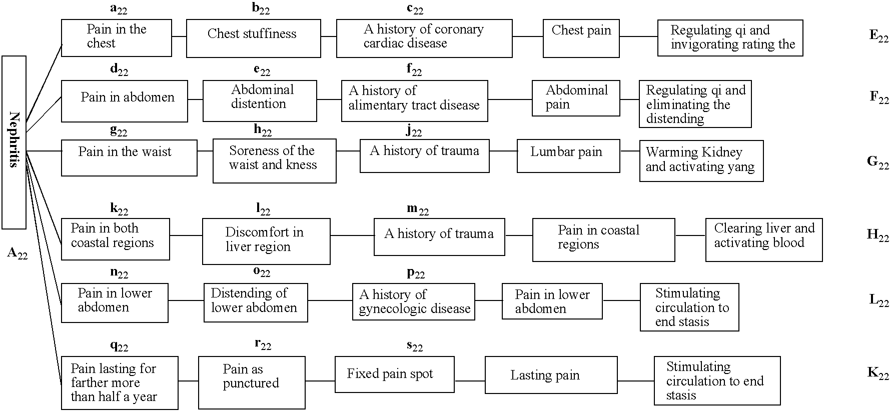

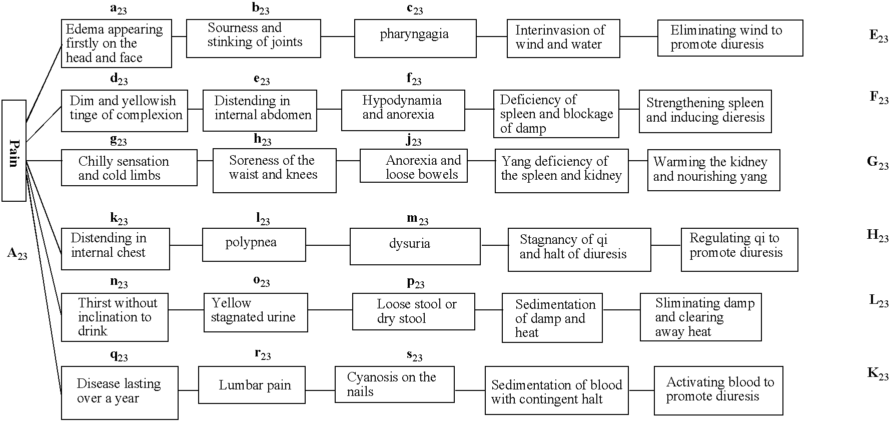

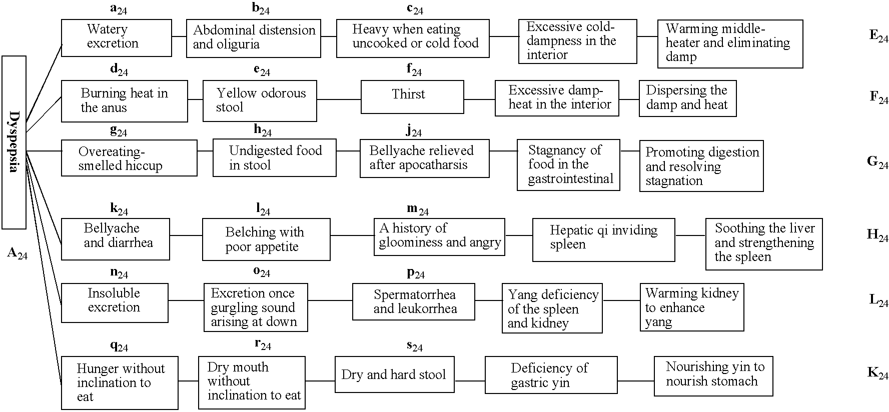

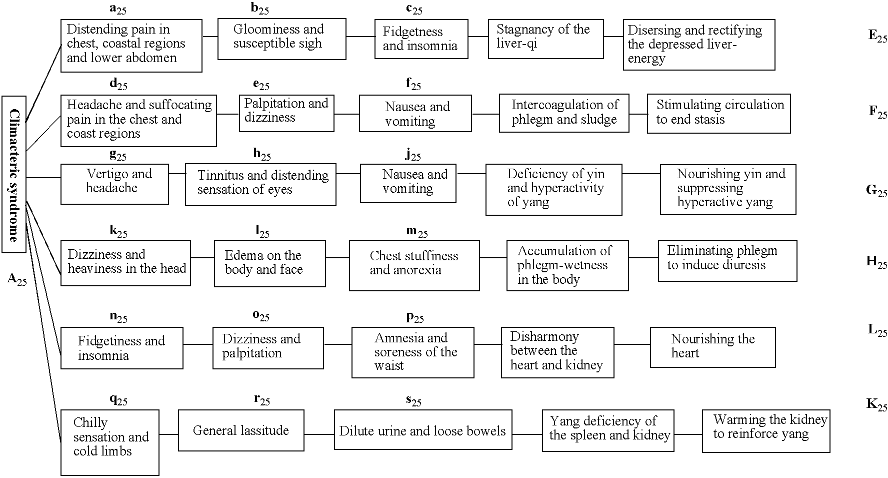

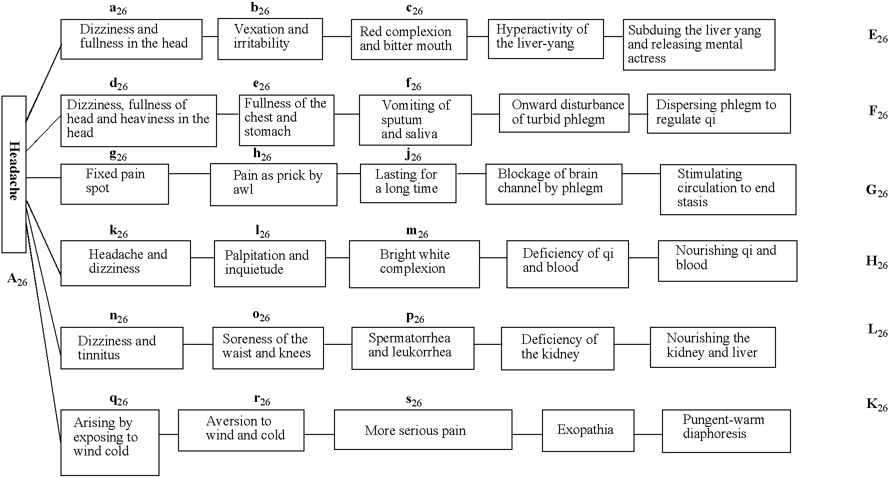

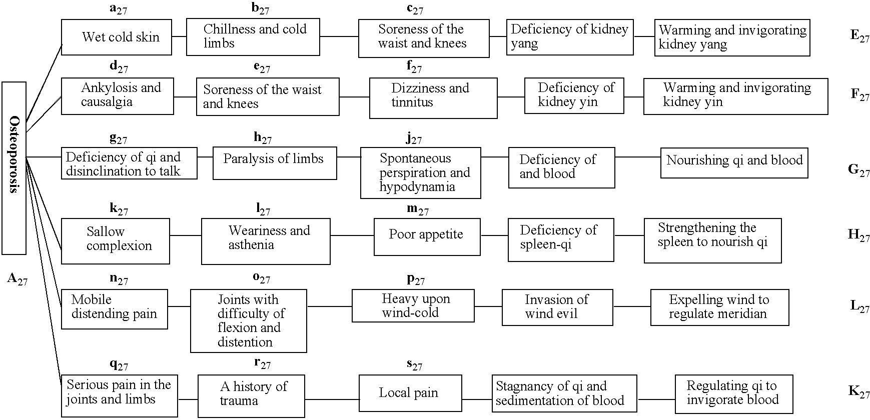

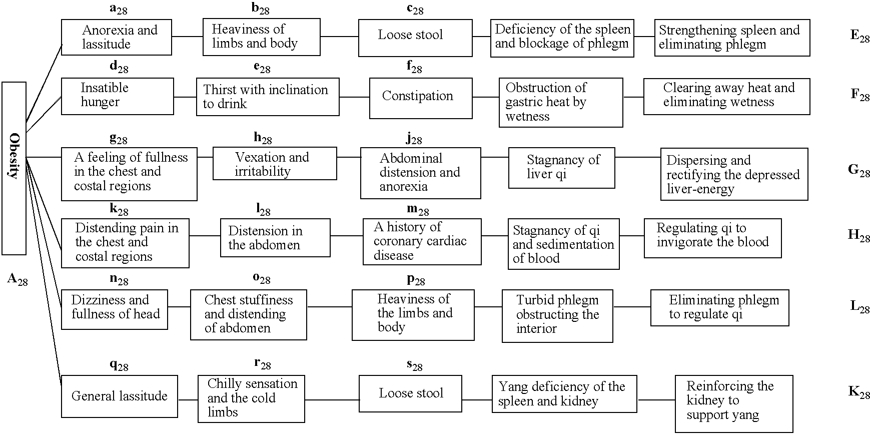

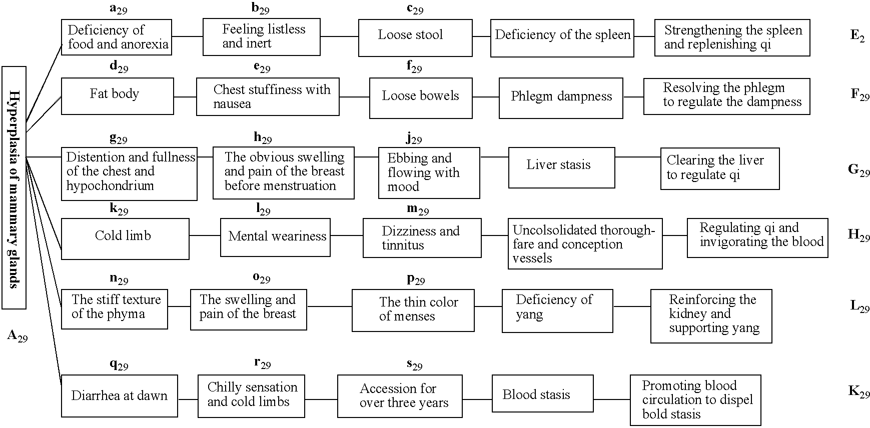

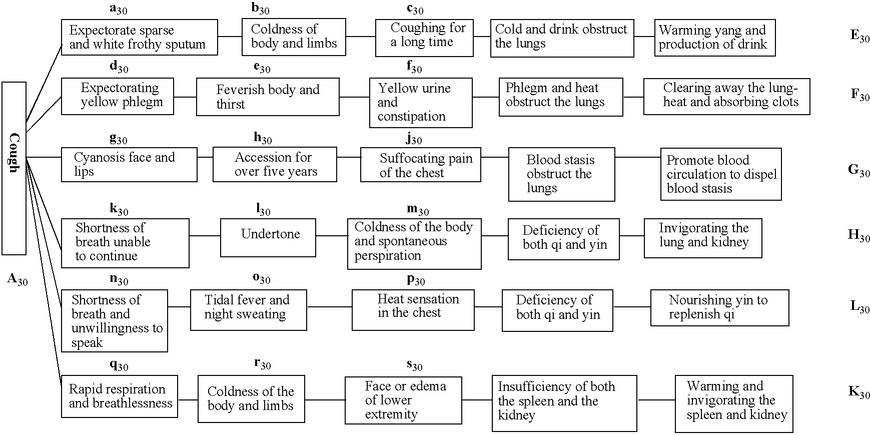

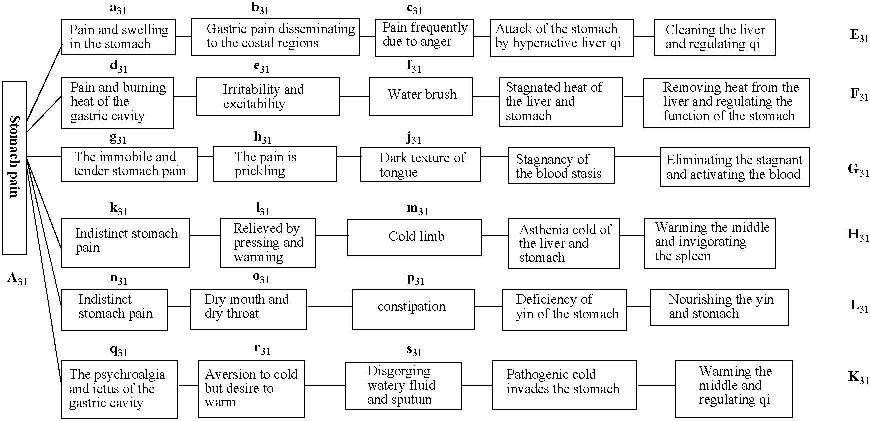

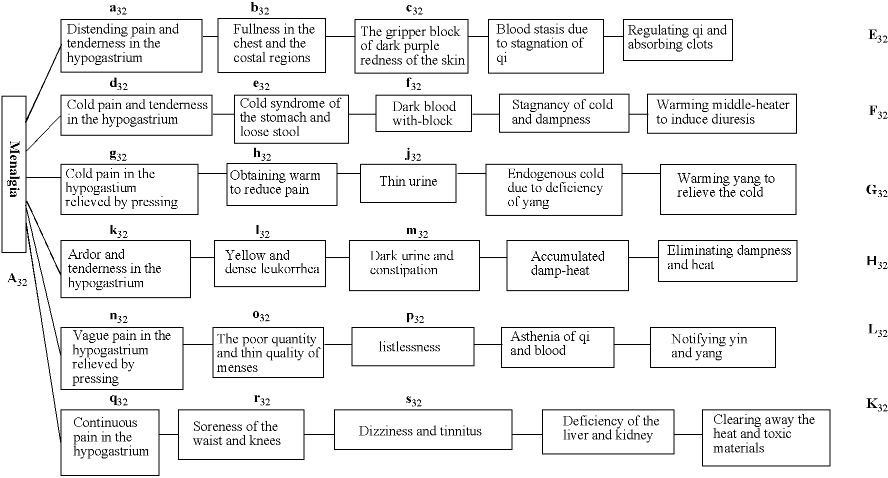

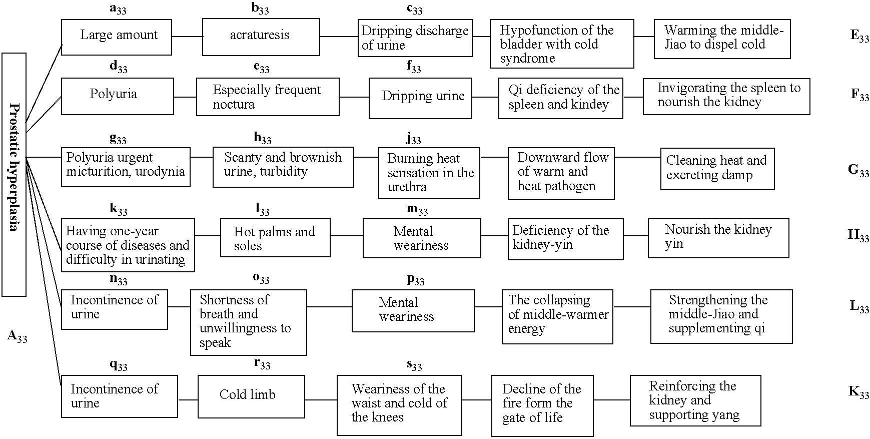

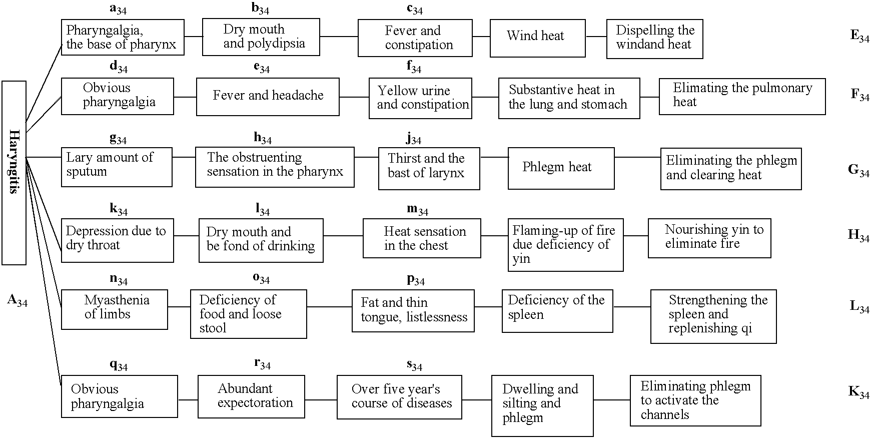

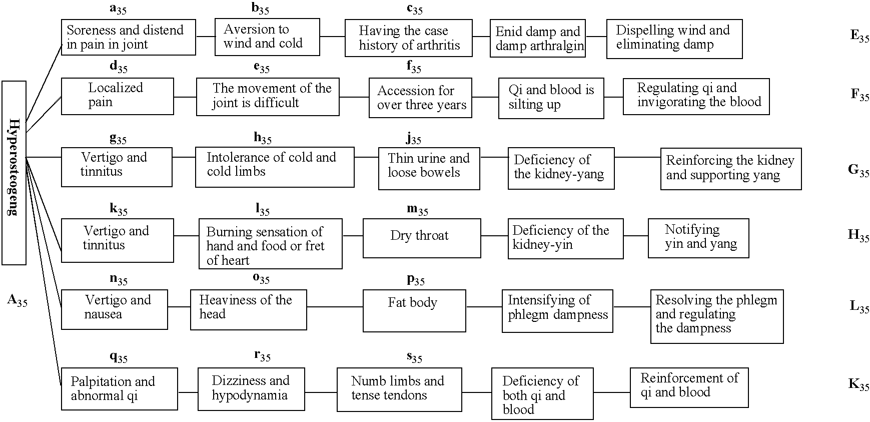

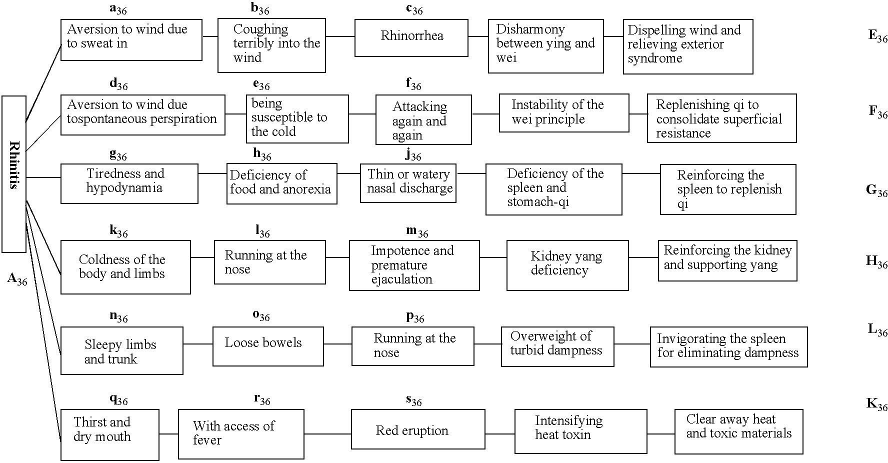

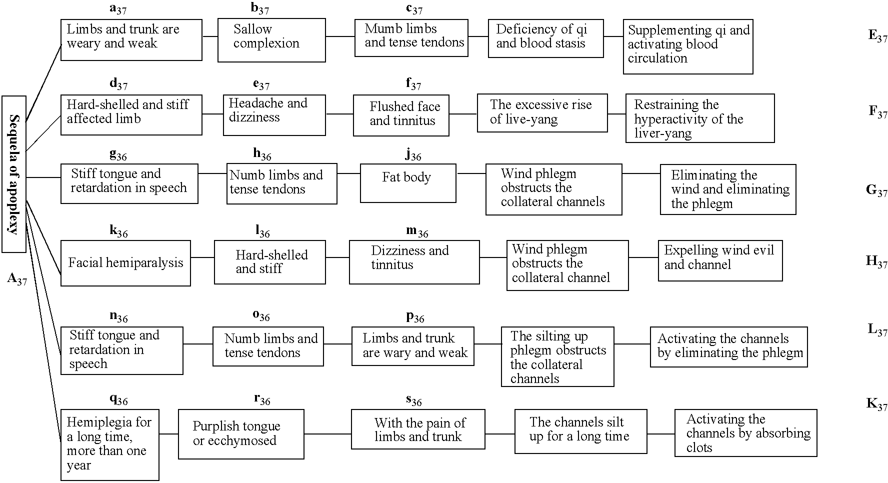

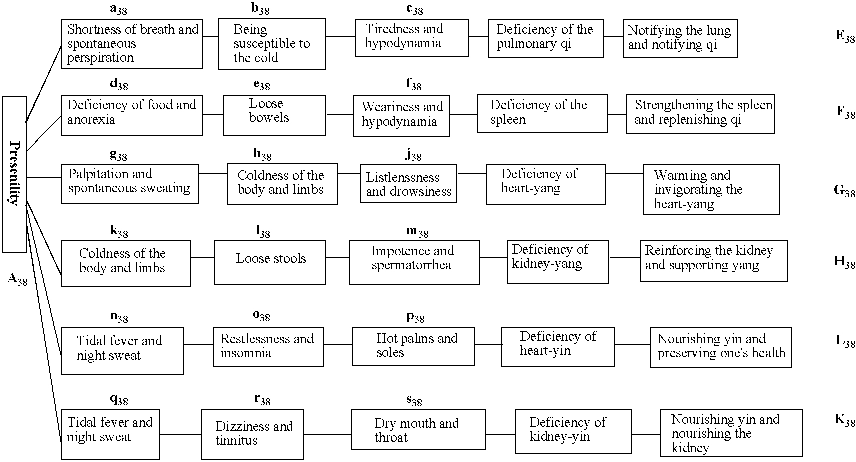

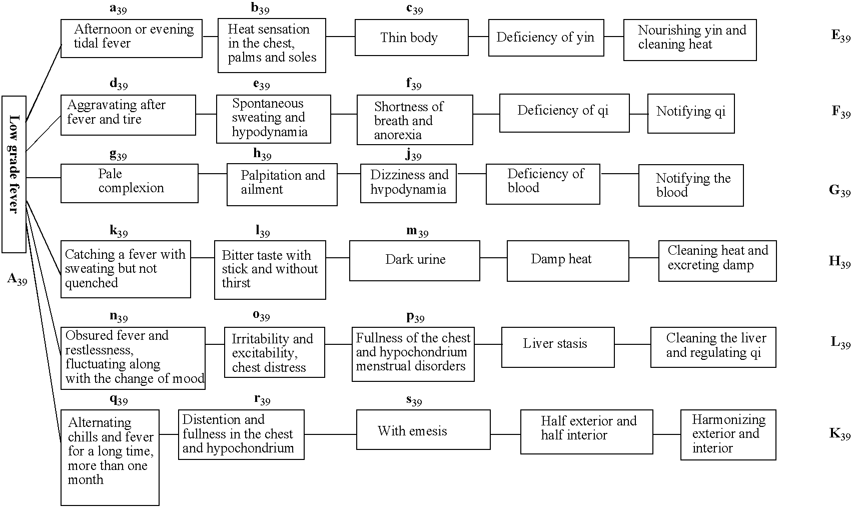

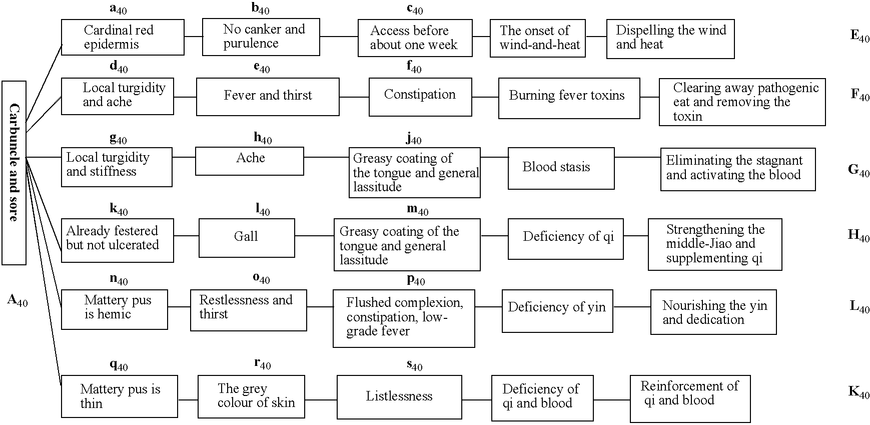

TABLE 4
Numbering structure of health diagnosis software of network hospital
(taking Senile cretinism as an example)

| | |
|---|---|
| 1. | a₂b₂ = a₂b₂ = b₂c₂ = a₂b₂c₂ = E₂ = A₂₋₁ = B₂₄ |
| 2. | d₂e₂ = d₂f₂ = e₂f₂ = d₂e₂f₂ = F₂ = A_{2—2} = B₂₄ |
| 3. | g₂h₂ = g₂j₂ = h₂j₂ = g₂h₂j₂ = G₂ = A₂₋₃ = B₂₅ |
| 4. | k₂l₂ = k₂m₂ = l₂m₂ = k₂l₂m₂ = H₂ = A₂₋₄ = B₃ |
| 5. | n₂o₂ = n₂p₂ = o₂p₂ = n₂o₂p₂ = L₂ = A₂₋₅ = B₁₆ |
| 6. | q₂r₂ = q₂s₂ = r₂s₂ = q₂r₂s₂ = k₂ = A₂₋₆ = B₁₅ |
| 7. | a₂b₂ = a₂b₂ = b₂c₂ = a₂b₂c₂ = d₂e₂ = d₂f₂ = e₂f₂ = d₂e₂f₂ = E₂F₂ = A₂₋₇ = B₂₄B₂₄ |
| 8. | a₂b₂ = a₂b₂ = b₂c₂ = a₂b₂c₂ = g₂h₂ = g₂j₂ = h₂j₂ = g₂h₂j₂ = E₂G₂ = A₂₋₈ = B₂₄B₂₅ |
| 9. | a₂b₂ = a₂b₂ = b₂c₂ = a₂b₂c₂ = k₂l₂ = k₂m₂ = l₂m₂ = k₂l₂m₂ = E₂H₂ = A₂₋₉ = B₂₄B₃ |
| 10. | a₂b₂ = a₂b₂ = b₂c₂ = a₂b₂c₂ = n₂o₂ = n₂p₂ = o₂p₂ = n₂o₂p₂ = E₂L₂ = A₂₋₁₀ = B₂₄B₁₆ |
| 11. | a₂b₂ = a₂b₂ = b₂c₂ = a₂b₂c₂ = q₂r₂ = q₂s₂ = r₂s₂ = q₂r₂s₂ = E₂k₂ = A₂₋₁₁ = B₂₄B₁₅ |
| 12. | d₂e₂ = d₂f₂ = e₂f₂ = d₂e₂f₂ = g₂h₂ = g₂j₂ = h₂j₂ = g₂h₂j₂ = F₂G₂ = A₂₋₁₂ = B₂₄B₂₅ |
| 13. | d₂e₂ = d₂f₂ = e₂f₂ = d₂e₂f₂ = k₂l₂ = k₂m₂ = l₂m₂ = k₂l₂m₂ = F₂H₂ = A₂₋₁₃ = B₂₄B₃ |
| 14. | d₂62 = d₂f₂ = e₂f₂ = d₂e₂f₂ = n₂o₂ = n₂p₂ = o₂p₂ = n₂o₂p₂ = F₂L₂ = A₂₋₁₄ = B₂₄B₁₆ |
| 15. | d₂e₂ = d₂f₂ = e₂f₂ = d₂e₂f₂ = q₂r₂ = q₂s₂ = r₂s₂ = q₂r₂s₂ = F₂k₂ = A₂₋₁₅ = B₂₄B₁₅ |
| 16. | g₂h₂ = g₂j₂ = h₂j₂ = g₂h₂j₂ = k₂l₂ = k₂m₂ = l₂m₂ = k₂l₂m₂ = G₂H₂ = A₂₋₁₆ = B₂₅B₃ |
| 17. | g₂h₂ = g₂j₂ = h₂j₂ = g₂h₂j₂ = n₂o₂ = n₂p₂ = o₂p₂ = n₂o₂p₂ = G₂L₂ = A₂₋₁₇ = B₂₅B₁₆ |
| 18. | g₂h₂ = g₂j₂ = h₂j₂ = g₂h₂j₂ = q₂r₂ = q₂s₂ = r₂s₂ = q₂r₂s₂ = G₂k₂ = A₂₋₁₈ = B₂₅B₁₅ |
| 19. | k₂l₂ = k₂m₂ = l₂m₂ = k₂l₂m₂ = n₂o₂ = n₂p₂ = o₂p₂ = n₂o₂p₂ = H₂L₂ = A₂₋₁₉ = B₃B₁₆ |
| 20. | k₂l₂ = k₂m₂ = l₂m₂ = k₂l₂m₂ = q₂r₂ = q₂s₂ = r₂s₂ = q₂r₂s₂ = H₂k₂ = A₂₋₂₀ = B₃B₁₅ |
| 21. | n₂o₂ = n₂p₂ = o₂p₂ = n₂o₂p₂ = q₂r₂ = q₂s₂ = r₂s₂ = q₂r₂s₂ = L₂k₂ = A₂₋₂₁ = B₁₆B₁₅ |
| 22. | a₂b₂ = a₂b₂ = b₂c₂ = a₂b₂c₂ = d₂e₂ = d₂f₂ = e₂f₂ = d₂e₂f₂ = g₂h₂ = g₂j₂ = h₂j₂ = g₂h₂j₂ = |
| | E₂F₂G₂ = A₂₋₂₂ = B₂₄B₂₅ |
| 23. | a₂b₂ = a₂b₂ = b₂c₂ = a₂b₂c₂ = g₂h₂ = g₂j₂ = h₂j₂ = g₂h₂j₂ = k₂l₂ = k₂m₂ = l₂m₂ = k₂l₂m₂ = |
| | E₂G₂H₂ = A₂₋₂₃ = BB |
| 24. | a₂b₂ = a₂b₂ = b₂c₂ = a₂b₂c₂ = k₂l₂ = k₂m₂ = l₂m₂ = k₂l₂m₂ = n₂o₂ = n₂p₂ = o₂p₂ = n₂o₂p₂ = |
| | E₂H₂L₂ = A₂₋₂₄ = B₃B₁₆ |
| 25. | a₂b₂ = a₂b₂ = b₂c₂ = a₂b₂c₂ = n₂o₂ = n₂p₂ = o₂p₂ = n₂o₂p₂ = q₂r₂ = q₂s₂ = r₂s₂ = q₂r₂s₂ = |
| | E₂L₂k₂ = A₂₋₂₅ = B₁₆B₁₅ |
| 26. | d₂e₂ = d₂f₂ = e₂f₂ = d₂e₂f₂ = g₂h₂ = g₂j₂ = h₂j₂ = g₂h₂j₂ = k₂l₂ = k₂m₂ = l₂m₂ = k₂l₂m₂ = |
| | F₂G₂H₂ = A₂₋₂₆ = BB |
| 27. | d₂e₂ = d₂f₂ = e₂f₂ = d₂e₂f₂ = k₂l₂ = k₂m₂ = l₂m₂ = k₂l₂m₂ = n₂o₂ = n₂p₂ = o₂p₂ = n₂o₂p₂ = |
| | F₂H₂L₂ = A₂₋₂₇ = B₃B₁₆ |
| 28. | d₂e₂ = d₂f₂ = e₂f₂ = d₂e₂f₂ = n₂o₂ = n₂p₂ = o₂p₂ = n₂o₂p₂ = q₂r₂ = q₂s₂ = r₂s₂ = q₂r₂s₂ = |
| | F₂L₂k₂ = A₂₋₂₈ = B₃B₁₅ |
| 29. | d₂e₂ = d₂f₂ = e₂f₂ = d₂e₂f₂ = q₂r₂ = q₂s₂ = r₂s₂ = q₂r₂s₂ = a₂b₂ = a₂b₂ = b₂c₂ = a₂b₂c₂ = |
| | F₂E₂k₂ = A₂₋₂₉ = B₂₄B₁₅ |
| 30. | g₂h₂ = g₂j₂ = h₂j₂ = g₂h₂j₂ = k₂l₂ = k₂m₂ = l₂m₂ = k₂l₂m₂ = n₂o₂ = n₂p₂ = o₂p₂ = n₂o₂p₂ = |
| | G₂H₂L₂ = A₂₋₃₀ = B₃B₁₆ |
| 31. | g₂h₂ = g₂j₂ = h₂j₂ = g₂h₂j₂ = n₂o₂ = n₂p₂ = o₂p₂ = n₂o₂p₂ = q₂r₂ = q₂s₂ = r₂s₂ = q₂r₂s₂ = |
| | G₂L₂k₂ = A₂₋₃₁ = B₁₆B₁₅ |
| 32. | g₂h₂ = g₂j₂ = h₂j₂ = g₂h₂j₂ = q₂r₂ = q₂s₂ = r₂s₂ = q₂r₂s₂ = a₂b₂ = a₂b₂ = b₂c₂ = a₂b₂c₂ = |
| | G₂k₂E₂ = A₂₋₃₂ = B₂₅B₂₄ |
| 33. | g₂h₂ = g₂j₂ = h₂j₂ = g₂h₂j₂ = a₂b₂ = a₂b₂ = b₂c₂ = a₂b₂c₂ = d₂e₂ = d₂f₂ = e₂f₂ = d₂e₂f₂ = |
| | G₂E₂F₂ = A₂₋₃₃ = B₂₅B₂₄ |
| 34. | k₂l₂ = k₂m₂ = l₂m₂ = k₂l₂m₂ = n₂o₂ = n₂p₂ = o₂p₂ = n₂o₂p₂ = q₂r₂ = q₂s₂ = r₂s₂ = q₂r₂s₂ = |
| | H₂L₂k₂ = A₂₋₃₄ = B₃B₁₆ |
| 35. | k₂l₂ = k₂m₂ = l₂m₂ = k₂l₂m₂ = q₂r₂ = q₂s₂ = r₂s₂ = q₂r₂s₂ = a₂b₂ = a₂b₂ = b₂c₂ = a₂b₂c₂ = |
| | H₂k₂E₂ = A₂₋₃₅ = B₃B₁₅ |
| 36. | k₂l₂ = k₂m₂ = l₂m₂ = k₂l₂m₂ = a₂b₂ = a₂b₂ = b₂c₂ = a₂b₂c₂ = d₂e₂ = d₂f₂ = e₂f₂ = d₂e₂f₂ = |
| | H₂E₂F₂ = A₂₋₃₆ = BB |
| 37. | k₂l₂ = k₂m₂ = l₂m₂ = k₂l₂m₂ = d₂e₂ = d₂f₂ = e₂f₂ = d₂e₂f₂ = g₂h₂ = g₂j₂ = h₂j₂ = g₂h₂j₂ = |
| | H₂F₂G₂ = A₂₋₃₇ = B₂₄B₂₅ |
| 38. | n₂o₂ = n₂p₂ = o₂p₂ = n₂o₂p₂ = q₂r₂ = q₂s₂ = r₂s₂ = q₂r₂s₂ = a₂b₂ = a₂b₂ = b₂c₂ = a₂b₂c₂ = |
| | L₂k₂E₂ = A₂₋₃₈ = B₃B₁₅ |
| 39. | n₂o₂ = n₂p₂ = o₂p₂ = n₂o₂p₂ = a₂b₂ = a₂b₂ = b₂c₂ = a₂b₂c₂ = d₂e₂ = d₂f₂ = g₂f₂ = d₂e₂f₂ = |
| | L₂E₂F₂ = A₂₋₃₉ = BB |
| 40. | n₂o₂ = n₂p₂ = o₂p₂ = n₂o₂p₂ = d₂e₂ = d₂f₂ = e₂f₂ = d₂e₂f₂ = g₂h₂ = g₂j₂ = h₂j₂ = g₂h₂j₂ = |
| | L₂F₂G₂ = A₂₋₄₀ = B₂₄B₂₅ |
| 41. | n₂o₂ = n₂p₂ = o₂p₂ = n₂o₂p₂ = g₂h₂ = g₂j₂ = h₂j₂ = g₂h₂j₂ = k₂l₂ = k₂m₂ = l₂m₂ = k₂l₂m₂ = |
| | L₂G₂H₂ = A₂₋₄₁ = B₁₆B₃ |
| 42. | q₂r₂ = q₂s₂ = r₂s₂ = q₂r₂s₂ = a₂b₂ = a₂b₂ = b₂c₂ = a₂b₂c₂ = d₂e₂ = d₂f₂ = e₂f₂ = d₂e₂f₂ = |
| | k₂E₂F₂ = A₂₋₄₂ = B₁₅B₂₄ |
| 43. | q₂r₂ = q₂s₂ = r₂s₂ = q₂r₂s₂ = d₂e₂ = d₂f₂ = e₂f₂ = d₂e₂f₂ = g₂h₂ = g₂j₂ = h₂j₂ = g₂h₂j₂ = |
| | k₂F₂G₂ = A₂₋₄₃ = B₂₄B₂₅ |
| 44. | q₂r₂ = q₂s₂ = r₂s₂ = q₂r₂s₂ = g₂h₂ = g₂j₂ = h₂j₂ = g₂h₂j₂ = k₂l₂ = k₂m₂ = l₂m₂ = k₂l₂m₂ = |
| | k₂G₂H₂ = A₂₋₄₄ = B₁₅B₃ |
| 45. | q₂r₂ = q₂s₂ = r₂s₂ = q₂r₂s₂ = k₂l₂ = k₂m₂ = l₂m₂ = k₂l₂m₂ = n₂o₂ = n₂p₂ = o₂p₂ = n₂o₂p₂ = |
| | k₂H₂L₂ = A₂₋₄₅ = B₃B₁₆ |
| 46. | a₂b₂ = a₂b₂ = b₂c₂ = a₂b₂c₂ = g₂h₂ = g₂j₂ = h₂j₂ = g₂h₂j₂ = n₂o₂ = n₂p₂ = o₂p₂ = n₂o₂p₂ = |
| | E₂G₂L₂ = A₂₋₄₆ = BB |
| 47. | a₂b₂ = a₂b₂ = b₂c₂ = a₂b₂c₂ = k₂l₂ = k₂m₂ = l₂m₂ = k₂l₂m₂ = q₂r₂ = q₂s₂ = r₂s₂ = q₂r₂s₂ = |
| | E₂H₂k₂ = A₂₋₄₇ = B₃B₁₅ |
| 48. | d₂e₂ = d₂f₂ = e₂f₂ = d₂e₂f₂ = k₂l₂ = k₂m₂ = l₂m₂ = k₂l₂m₂ = q₂r₂ = q₂s₂ = r₂s₂ = q₂r₂s₂ = |
| | F₂H₂k₂ = A₂₋₄₈ = B₃B₁₅ |
| 49. | d₂e₂ = d₂f₂ = e₂f₂ = d₂e₂f₂ = n₂o₂ = n₂p₂ = o₂p₂ = n₂o₂p₂ = a₂b₂ = a₂b₂ = b₂c₂ = a₂b₂c₂ = |
| | F₂L₂E₂ = A₂₋₄₉ = B₂₄B₂₅ |
| 50. | g₂h₂ = g₂j₂ = h₂j₂ = g₂h₂j₂ = n₂o₂ = n₂p₂ = o₂p₂ = n₂o₂p₂ = a₂b₂ = a₂b₂ = b₂c₂ = a₂b₂c₂ = |
| | G₂L₂E₂ = A₂₋₅₀ = B₂₅B₂₄ |
| 51. | g₂h₂ = g₂j₂ = h₂j₂ = g₂h₂j₂ = q₂r₂ = q₂s₂ = r₂s₂ = q₂r₂s₂ = d₂e₂ = d₂f₂ = e₂f₂ = d₂e₂f₂ = |
| | Gk₂F₂ = A₂₋₅₁ = B₂₅B₂₄ |
| 52. | k₂l₂ = k₂m₂ = l₂m₂ = k₂l₂m₂ = q₂r₂ = q₂s₂ = r₂s₂ = q₂r₂s₂ = d₂e₂ = d₂f₂ = e₂f₂ = d₂e₂f₂ = |
| | H₂k₂F₂ = A₂₋₅₂ = B₃B₁₅ |
| 53. | k₂l₂ = k₂m₂ = l₂m₂ = k₂l₂m₂ = a₂b₂ = a₂b₂ = b₂c₂ = a₂b₂c₂ = g₂h₂ = g₂j₂ = h₂j₂ = g₂h₂j₂ = |
| | H₂E₂G₂ = A₂₋₅₃ = B₂₄B₂₅ |
| 54. | n₂o₂ = n₂p₂ = o₂p₂ = n₂o₂p₂ = a₂b₂ = a₂b₂ = b₂c₂ = a₂b₂c₂ = g₂h₂ = g₂j₂ = h₂j₂ = g₂h₂j₂ = |
| | L₂E₂G₂ = A₂₋₅₄ = B₂₄B₂₅ |
| 55. | n₂o₂ = n₂p₂ = o₂p₂ = n₂o₂p₂ = d₂e₂ = d₂f₂ = e₂f₂ = d₂e₂f₂ = k₂l₂ = k₂m₂ = l₂m₂ = k₂l₂m₂ = |
| | L₂F₂H₂ = A₂₋₅₅ = B₁₆B₃ |
| 56. | q₂r₂ = q₂s₂ = r₂s₂ = q₂r₂s₂ = d₂e₂ = d₂f₂ = e₂f₂ = d₂e₂f₂ = k₂l₂ = k₂m₂ = l₂m₂ = k₂l₂m₂ = |
| | k₂F₂H₂ = A₂₋₅₆ = B₁₅B₃ |
| 57. | q₂r₂ = q₂s₂ = r₂s₂ = q₂r₂s₂ = g₂h₂ = g₂j₂ = h₂j₂ = g₂h₂j₂ = n₂o₂ = n₂p₂ = o₂p₂ = n₂o₂p₂ = |
| | k₂G₂L₂ = A₂₋₅₇ = B₁₅B₁₆ |
| 58. | a₂b₂ = a₂b₂ = b₂c₂ = a₂b₂c₂ = d₂e₂ = d₂f₂ = e₂f₂ = d₂e₂f₂ = g₂h₂ = g₂j₂ = h₂j₂ = g₂h₂j₂ = |
| | k₂l₂ = k₂m₂ = l₂m₂ = k₂l₂m₂ = E₂F₂G₂H₂ = A₂₋₅₈ = B₂₄B₂₅ |
| 59. | a₂b₂ = a₂b₂ = b₂c₂ = a₂b₂c₂ = g₂h₂ = g₂j₂ = h₂j₂ = g₂h₂j₂ = k₂l₂ = k₂m₂ = l₂m₂ = k₂l₂m₂ = |
| | n₂o₂ = n₂p₂ = o₂p₂ = n₂o₂p₂ = E₂G₂H₂L₂ = A₂₋₅₉ = B₃B₁₆ |
| 60. | a₂b₂ = a₂b₂ = b₂c₂ = a₂b₂c₂ = k₂l₂ = k₂m₂ = l₂m₂ = k₂l₂m₂ = n₂o₂ = n₂p₂ = o₂p₂ = n₂o₂p₂ = |
| | q₂r₂ = q₂s₂ = r₂s₂ = q₂r₂s₂ = E₂H₂L₂k₂ = A₂₋₆₀ = B₃B₁₆ |
| 61. | d₂e₂ = d₂f₂ = e₂f₂ = d₂e₂f₂ = g₂h₂ = g₂j₂ = h₂j₂ = g₂h₂j₂ = k₂l₂ = k₂m₂ = l₂m₂ = k₂l₂m₂ = |
| | n₂o₂ = n₂p₂ = o₂p₂ = n₂o₂p₂ = F₂G₂H₂L₂ = A_{2-61 =} B₃B₁₆ |
| 62. | d₂e₂ = d₂f₂ = e₂f₂ = d₂e₂f₂ = k₂l₂ = k₂m₂ = l₂m₂ = k₂l₂m₂ = n₂o₂ = n₂p₂ = o₂p₂ = n₂o₂p₂ = |
| | q₂r₂ = q₂s₂ = r₂s₂ = q₂r₂s₂ = F₂H₂L₂k₂ = A₂₋₆₂ = B₃B₁₆ |
| 63. | d₂e₂ = d₂f₂ = e₂f₂ = d₂e₂f₂ = n₂o₂ = n₂p₂ = o₂p₂ = n₂o₂p₂ = q₂r₂ = q₂s₂ = r₂s₂ = q₂r₂s₂ = |
| | a₂b₂ = a₂b₂ = b₂c₂ = a₂b₂c₂ = F₂L₂k₂E₂ = A₂₋₆₃ = B₁₆B₁₅ |
| 64. | g₂h₂ = g₂j₂ = h₂j₂ = g₂h₂j₂ = k₂l₂ = k₂m₂ = l₂m₂ = k₂l₂m₂ = n₂o₂ = n₂p₂ = o₂p₂ = n₂o₂p₂ = |
| | q₂r₂ = q₂s₂ = r₂s₂ = q₂r₂s₂ = G₂H₂L₂k₂ = A₂₋₆₄ = B₃B₁₆ |
| 65. | g₂h₂ = g₂j₂ = h₂j₂ = g₂h₂j₂ = n₂o₂ = n₂p₂ = o₂p₂ = n₂o₂p₂ = q₂r₂ = q₂s₂ = r₂s₂ = q₂r₂s₂ = |
| | a₂b₂ = a₂b₂ = b₂c₂ = a₂b₂c₂ = = G₂L₂k₂E₂ = A₂₋₆₅ = B₁₆B₁₅ |
| 66. | g₂h₂ = g₂j₂ = h₂j₂ = g₂h₂j₂ = q₂r₂ = q₂s₂ = r₂s₂ = q₂r₂s₂ = a₂b₂ = a₂b₂ = b₂c₂ = a₂b₂c₂ = |
| | d₂e₂ = d₂f₂ = e₂f₂ = d₂e₂f₂ = G₂k₂E₂F₂ = A₂₋₆₆ = B₁₅B₃ |
| 67. | k₂l₂ = k₂m₂ = l₂m₂ = k₂l₂m₂ = n₂o₂ = n₂p₂ = o₂p₂ = n₂o₂p₂ = q₂r₂ = q₂s₂ = r₂s₂ = q₂r₂s₂ = |
| | a₂b₂ = a₂b₂ = b₂c₂ = a₂b₂c₂ = H₂L₂k₂E₂ = A₂₋₆₇ = B₃B₁₆ |
| 68. | k₂l₂ = k₂m₂ = l₂m₂ = k₂l₂m₂ = q₂r₂ = q₂s₂ = r₂s₂ = q₂r₂s₂ = a₂b₂ = a₂b₂ = b₂c₂ = a₂b₂c₂ = |
| | d₂e₂ = d₂f₂ = e₂f₂ = d₂e₂f₂ = H₂k₂E₂F₂ = A₂₋₆₈ = B₃B₁₅ |
| 69. | k₂l₂ = k₂m₂ = l₂m₂ = k₂l₂m₂ = a₂b₂ = a₂b₂ = b₂c₂ = a₂b₂c₂ = d₂e₂ = d₂f₂ = e₂f₂ = d₂e₂f₂ = |
| | g₂h₂ = g₂j₂ = h₂j₂ = g₂h₂j₂ = H₂E₂F₂G₂ = A₂₋₆₉ = B₂₄B₂₅ |
| 70. | n₂o₂ = n₂p₂ = o₂p₂ = n₂o₂p₂ = q₂r₂ = q₂s₂ = r₂s₂ = q₂r₂s₂ = a₂b₂ = a₂b₂ = b₂c₂ = a₂b₂c₂ = |
| | d₂e₂ = d₂f₂ = e₂f₂ = d₂e₂f₂ = L₂k₂E₂F₂ = A₂₋₇₀ = B₁₆B₁₅ |
| 71. | n₂o₂ = n₂p₂ = o₂p₂ = n₂o₂p₂ = a₂b₂ = a₂b₂ = b₂c₂ = a₂b₂c₂ = d₂e₂ = d₂f₂ = e₂f₂ = d₂e₂f₂ = |
| | g₂h₂ = g₂j₂ = h₂j₂ = g₂h₂j₂ = L₂E₂F₂G₂ = A₂₋₇₁ = B₂₄B₂₅ |
| 72. | n₂o₂ = n₂p₂ = o₂p₂ = n₂o₂p₂d₂e₂ = d₂f₂ = e₂f₂ = d₂e₂f₂ = g₂h₂ = g₂j₂ = h₂j₂ = g₂h₂j₂ = |
| | k₂l₂ = k₂m₂ = l₂m₂ = k₂l₂m₂ = L₂F₂G₂H₂ = A₂₋₇₂ = B₁₆B₃ |
| 73. | q₂r₂ = q₂s₂ = r₂s₂ = q₂r₂s₂ = a₂b₂ = a₂b₂ = b₂c₂ = a₂b₂c₂ = d₂e₂ = d₂f₂ = e₂f₂ = d₂e₂f₂ = |
| | g₂h₂ = g₂j₂ = h₂j₂ = g₂h₂j₂ = k₂E₂G₂F₂ = A₂₋₇₃ = B₂₄B₂₅ |
| 74. | q₂r₂ = q₂s₂ = r₂s₂ = q₂r₂s₂ = d₂e₂ = d₂f₂ = e₂f₂ = d₂e₂f₂ = g₂h₂ = g₂j₂ = h₂j₂ = g₂h₂j₂ = |
| | k₂l₂ = k₂m₂ = l₂m₂ = k₂l₂m₂ = k₂F₂G₂H₂ = A₂₋₇₄ = B₁₅B₃ |
| 75. | q₂r₂ = q₂s₂ = r₂s₂ = q₂r₂s₂ = g₂h₂ = g₂j₂ = h₂j₂ = g₂h₂j₂ = k₂l₂ = k₂m₂ = l₂m₂ = k₂l₂m₂ = |
| | n₂o₂ = n₂p₂ = o₂p₂ = n₂o₂p₂ = k₂L₂H₂G₂ = A₂₋₇₅ = B₃B₁₆ |
| 76. | a₂b₂ = a₂b₂ = b₂c₂ = a₂b₂c₂ = d₂e₂ = d₂f₂ = e₂f₂ = d₂e₂f₂ = k₂l₂ = k₂m₂ = l₂m₂ = k₂l₂m₂ = |
| | n₂o₂ = n₂p₂ = o₂p₂ = n₂o₂p₂ = E₂F₂H₂L₂ = A₂₋₇₆ = B₃B₁₆ |
| 77. | a₂b₂ = a₂b₂ = b₂c₂ = a₂b₂c₂ = d₂e₂ = d₂f₂ = e₂f₂ = d₂e₂f₂ = n₂o₂ = n₂p₂ = o₂p₂ = n₂o₂p₂ = |
| | q₂r₂ = q₂s₂ = r₂s₂ = q₂r₂s₂ = k₂F₂L₂E₂ = A₂₋₇₇ = B₁₆B₁₅ |
| 78. | d₂e₂ = d₂f₂ = e₂f₂ = d₂e₂f₂ = F₂ = g₂h₂ = g₂j₂ = h₂j₂ = g₂h₂j₂ = n₂o₂ = n₂p₂ = o₂p₂ = n₂o₂p₂ = |
| | q₂r₂ = q₂s₂ = r₂s₂ = q₂r₂s₂ = A₂G₂L₂k₂ = A₂₋₇₈ = B₁₆ B₁₅ |
| 79. | d₂e₂ = d₂f₂ = e₂f₂ = d₂e₂f₂ = g₂h₂ = g₂j₂ = h₂j₂ = g₂h₂j₂ = q₂r₂ = q₂s₂ = r₂s₂ = q₂r₂s₂ = |
| | a₂b₂ = a₂b₂ = b₂c₂ = a₂b₂c₂ = F₂G₂k₂E₂ = A₂₋₇₉ = B₂₄B₂₅ |
| 80. | g₂h₂ = g₂j₂ = h₂j₂ = g₂h₂j₂ = k₂l₂ = k₂m₂ = l₂m₂ = k₂l₂m₂ = q₂r₂ = q₂s₂ = r₂s₂ = q₂r₂s₂ = |
| | a₂b₂ = a₂b₂ = b₂c₂ = a₂b₂c₂ = G₂H₂k₂E₂ = A₂₋₈₀ = B₃B₁₅ |
| 81. | g₂h₂ = g₂j₂ = h₂j₂ = g₂h₂j₂ = k₂l₂ = k₂m₂ = l₂m₂ = k₂l₂m₂ = a₂b₂ = a₂b₂ = b₂c₂ = a₂b₂c₂ = |
| | d₂e₂ = d₂f₂ = e₂f₂ = d₂e₂f₂ = G₂H₂E₂F₂ = A₂₋₈₁ = B₂₅B₂₄ |
| 82. | k₂l₂ = k₂m₂ = l₂m₂ = k₂l₂m₂ = n₂o₂ = n₂p₂ = o₂p₂ = n₂o₂p₂ = a₂b₂ = a₂b₂ = b₂c₂ = a₂b₂c₂ = |
| | d₂e₂ = d₂f₂ = e₂f₂ = d₂e₂f₂ = H₂L₂E₂F₂ = A₂₋₈₂ = B₃B₁₆ |
| 83. | k₂l₂ = k₂m₂ = l₂m₂ = k₂l₂m₂ = n₂o₂ = n₂p₂ = o₂p₂ = n₂o₂p₂ = d₂e₂ = d₂f₂ = e₂f₂ = d₂e₂f₂ = |
| | g₂h₂ = g₂j₂ = h₂j₂ = g₂h₂j₂ = H₂L₂F₂G₂ = A₂₋₈₃ = B₃B₁₆ |
| 84. | n₂o₂ = n₂p₂ = o₂p₂ = n₂o₂p₂ = q₂r₂ = q₂s₂ = r₂s₂ = q₂r₂s₂ = g₂h₂ = g₂j₂ = h₂j₂ = g₂h₂j₂ = |
| | k₂l₂ = k₂m₂ = l₂m₂ = k₂l₂m₂ = L₂k₂G₂H₂ = A₂₋₈₄ = B₁₆B₃ |
| 85. | q₂r₂ = q₂s₂ = r₂s₂ = q₂r₂s₂ = a₂b₂ = a₂b₂ = b₂c₂ = a₂b₂c₂ = g₂h₂ = g₂j₂ = h₂j₂ = g₂h₂j₂ = |
| | k₂l₂ = k₂m₂ = l₂m₂ = k₂l₂m₂ = k₂E₂G₂H₂ = A₂₋₈₅ = B₁₅B₃ |
| 86. | q₂r₂ = q₂s₂ = r₂s₂ = q₂r₂s₂ = a₂b₂ = a₂b₂ = b₂c₂ = a₂b₂c₂ = k₂l₂ = k₂m₂ = l₂m₂ = k₂l₂m₂ = |
| | n₂o₂ = n₂p₂ = o₂p₂ = n₂o₂p₂ = k₂E₂H₂L₂ = A₂₋₈₆ = B₃B₁₆ |
| 87. | a₂b₂ = a₂b₂ = b₂c₂ = a₂b₂c₂ = g₂h₂ = g₂j₂ = h₂j₂ = g₂h₂j₂ = n₂o₂ = n₂p₂ = o₂p₂ = n₂o₂p₂ = |
| | q₂r₂ = q₂s₂ = r₂s₂ = q₂r₂s₂ = E₂G₂L₂k₂ = A₂₋₈₇ = B₁₆B₁₅ |
| 88. | d₂e₂ = d₂f₂ = e₂f₂ = d₂e₂f₂ = k₂l₂ = k₂m₂ = l₂m₂ = k₂l₂m₂ = q₂r₂ = q₂s₂ = r₂s₂ = q₂r₂s₂ = |
| | a₂b₂ = a₂b₂ = b₂c₂ = a₂b₂c₂ = F₂H₂k₂E₂ = A₂₋₈₈ = B₃B₁₅ |
| 89. | g₂h₂ = g₂j₂ = h₂j₂ = g₂h₂j₂ = n₂o₂ = n₂p₂ = o₂p₂ = n₂o₂p₂ = a₂b₂ = a₂b₂ = b₂c₂ = |
| | a₂b₂c₂ = d₂e₂ = d₂f₂ = e₂f₂ = d₂e₂f₂ = G₂L₂E₂F₂ = A₂₋₈₉ = B₂₅B₂₄ |
| 90. | k₂l₂ = k₂m₂ = l₂m₂ = k₂l₂m₂ = q₂r₂ = q₂s₂ = r₂s₂ = q₂r₂s₂ = d₂e₂ = d₂f₂ = e₂f₂ = d₂e₂f₂ = |
| | g₂h₂ = g₂j₂ = h₂j₂ = g₂h₂j₂ = H₂k₂F₂G₂ = A₂₋₉₀ = B₃B₁₅ |
| 91. | n₂o₂ = n₂p₂ = o₂p₂ = n₂o₂p₂ = a₂b₂ = a₂b₂ = b₂c₂ = a₂b₂c₂ = g₂h₂ = g₂j₂ = h₂j₂ = g₂h₂j₂ = |
| | k₂l₂ = k₂m₂ = l₂m₂ = k₂l₂m₂ = L₂E₂G₂H₂ = A₂₋₉₁ = B₁₆B₃ |
| 92. | q₂r₂ = q₂s₂ = r₂s₂ = q₂r₂s₂ = d₂e₂ = d₂f₂ = e₂f₂ = d₂e₂f₂ = k₂l₂ = k₂m₂ = l₂m₂ = |
| | k₂l₂m₂ = n₂o₂ = n₂p₂ = o₂p₂ = n₂o₂p₂ = k₂F₂H₂L₂ = A₂₋₉₂ = B₃B₁₆ |

TABLE 5
Corresponding recipe of health invigorating
substances for 40 diseases.

A₁ Macula resolving and acne formula label

| | |
|---|---|
| Concentrated Powder from Buffalo Horn | 1.66% |
| Dried Garden Ginseng | 6.66% |
| Lucid Ganoderma | 12.5% |
| Dried rhizome of Rehmannia | 33.34% |
| Fruit of Beautiful Sweetgum | 12.5% |
| Root of Costal Glehnia | 4.18% |
| Motherwort Herb | 16.66% |
| Root of Tonkin Sophora | 12.5% |
| Total | 100% |

A₂ Senile cretinism formula label

| | |
|---|---|
| Rhizome of Grassleaf Sweetflag | 8.45% |
| Dried Rhizome of Adhesive Rehnmannia | 11.66% |
| Tuber of Dwarf Lilyturf | 11.66% |
| Root of Tuber Fleece flower | 5.63% |
| Radix Salviae Miltiorrhizae | 5.63% |
| Radix Notoginseng | 3.52% |
| Ginseng | 5.63% |
| Rhizome of Driental Waterplantain | 5.63% |
| Liquorice Root | 5.63% |
| Herb of Shorthorned Epimedium | 5.63% |
| Root of Thinleaf Milkwort | 2.82% |
| Fruit of Chinese Magnoliavine | 5.63% |
| Fruit of Asiatic Cornelian | 5.63% |
| Eucommia Bark | 5.63% |
| Bulb of Tendrilleaf Fritillary | 5.63% |
| Total | 100% |

A₃ Anemia formula label

| | |
|---|---|
| Root of Mongolian Milkvetch | 13.42% |
| Chinese Angelica | 10.83% |
| Rhizome of Szechwan Lovage | 8.87% |
| Motherdwort Herb | 26.85% |
| Dodder Seed | 8.87% |
| Adhesive Rehmannica | 13.42% |
| Root of Tuber Fleeceflower | 8.87% |
| Herb of Shorthorned Epimedium | 8.87% |
| Total | 100% |

A₄ Neurasthenia formula label

| | |
|---|---|
| Jujube | 33.21% |
| Radix Salviae Miltiorrhizae | 23.72% |
| Prepared Rhizome of Adhesive Rehmannia | 11.86% |
| Tangerine Peel | 5.98% |
| Rhizome of Largehead Atractyloades | 8.92% |
| Stem of Tuber Fleeceflower | 11.86% |
| Root of Thinleaf Milkwort | 4.45% |
| Total | 100% |

A₅ Arthritis formula label

| | |
|---|---|
| Herb of Common St.Paulswort | 9.72% |
| Rhizome of East Asian Tree Fern | 13.49% |
| Herb of Common Clubmoss | 13.49% |
| Rhiazome of Szechwan Lovage | 6.49% |
| Cassia Bark | 1.62% |
| Costusroot | 1.62% |
| Stem of Suberect Spatholobus | 3.89% |
| Root of Largeeaf Gentian | 13.49% |
| Herb of Wilford Cranesbill | 6.49% |
| Root of Fourstamen Stephania | 9.72% |
| Root of Doubleteeth Pubscent Angelica | 6.24% |
| Mulberry Twig | 6.49% |
| Root-bark of Slenderslyle Acanthopanax | 6.24% |
| Total | 100% |

A₆ Tracheal catarrh formula label

| | |
|---|---|
| Honeysuckle Flower | 29.18% |
| Capsule of Weeping Forsythia | 29.18% |
| Root of Baikal Skullcap | 14.40% |
| Red Peony Root | 13.51% |
| Rhubarb | 9.73% |
| Total | 100% |

A₇ Vaginitis formula label

| | |
|---|---|
| Honetsuckle Stem | 24.39% |
| Stem of Sargentgloryvine | 24.39% |
| Leaf of Indigowoad | 7.32% |
| Rhizoma Corydalis | 7.32% |
| Rhizome of Oriental Waterplantain | 4.88% |
| Liquorice Root | 2.44% |
| Red Peony Root | 7.32% |
| Dandelion | 7.32% |
| Tree Peony Bark | 7.32% |
| Fruit of Szechwan Chinaberry | 7.32% |
| Total | 100% |

A₈ Long term apocamnosis formula label

| | |
|---|---|
| Dried Garden Ginseng | 25% |
| Adhesive Rehmannia | 25% |
| Rhizome of Oriental Waterplantain | 25% |
| Herb of Shorthorned Epimedium | 25% |
| Total | 100% |

A₉ Rheum formula label

| | |
|---|---|
| Root of Lobed Kudzuvine | 13.91% |
| Herb of Wild Mint | 5.56% |
| Cicade Slough | 2.80% |
| Rhizome of Lalang Grass | 8.30% |
| Safflower | 2.80% |
| Raw Gypsum | 19.42% |
| Root of Indigowoad | 11.1% |
| Rhizome of Asiatic Moonsead | 8.31% |
| Honeysuckle Flower | 5.56% |
| Reed Rhizome | 8.30% |
| Herb of Spreading Hedyotis | 13.91% |
| Total | 100% |

A₁₀ Coronary heart disease formula label

| | |
|---|---|
| Radix Salviae Miltiorrhizae | 12% |
| Radix Notoginseng | 3% |
| Rhizome of Szechwan Lovage | 9% |
| Safflower | 8% |
| Herb of Shorthorned Epimedium | 10% |
| Root of Lobed Kudzuvine | 7% |
| Root of Twotooth Achyranthes | 8% |
| Ginseng | 12% |
| Root of Mongolian Milkvetch | 12% |
| Fruit of Chinese Magnoliavine | 7% |
| Root of Tuber Fleece flower | 7% |
| Cassia Bark | 5% |
| Total | 100% |

A₁₁ Diabetes formula label

| | |
|---|---|
| Lucid Ganoderma | 14.81% |
| Fruit of Chinese Magnoliavine | 7.41% |
| Dogger Seed | 5.56% |
| Ginseng | 5.56% |
| Root of Mongolian Milkvetch | 7.41% |
| Figdwort Angelica | 5.56% |
| Chinese Angelica | 7.41% |
| Dendrobium Stem | 5.56% |
| Tree Peony Bark | 7.41% |
| Fruit of Glossy Privet | 5.56% |
| Root of Lobed Kudzuvine | 5.56% |
| Radix Salviae Miltiorrhizae | 7.41% |
| Rhizome of Siberian Solomon seal | 7.41% |
| Root bark of Chinese Wolfberry | 7.41% |
| Total | 100% |

A₁₂ Dermatosis formula label

| | |
|---|---|
| Dictammus Dasycarpus | 17.14% |
| Fruit of Malaytea Scurfpea | 14.29% |
| Fruit of Common Cnidium | 8.57% |
| Root of Dahurian Angelica | 14.29% |
| Herb of Fineleaf Schizonepeta | 11.43% |
| Adhesive Rehmannia | 8.57% |
| Root of Divaricate Saposhnikovia | 14.29% |
| Herb of Common Andrographis | 11.43% |
| Total | 100% |

A₁₃ Elevated blood fat formula label

| | |
|---|---|
| Rhizome of Oriental Waterplantain | 25% |
| Turmeric | 16.67% |
| Fiveleaf Gynostemma | 20.83% |
| Fruit of Glossy Privet | 20.83% |
| Herb of Shorthorned Epimedium | 16.67% |
| Total | 100% |

A₁₄ Decline of sexual function formula label

| | |
|---|---|
| Male Silk Moth | 62.24% |
| Dried Garden Ginseng | 6.22% |
| Herb of Shorthorned Epimedium | 4.15% |
| Hairy Antler | 1.037% |
| Rhizima Corydalis | 5.15% |
| Fruit of Chinese Magnoliavine | 2.075% |
| Dodder Seed | 2.075% |
| Root of Twotooth Achyranthes | 4.15% |
| Fruit if Common Cnidium | 1.037% |
| Rhizome of Common Curculigo | 3.32% |
| Cassia Bark | 2.075% |
| Seed of Common Fenugreek | 3.32% |
| Fennel Fruit | 1.037% |
| Seed of Tuber Onion | 2.075% |
| Desert living Cistanche | 1.037% |
| Total | 100% |

A₁₅ Cholecystitis formula label

| | |
|---|---|
| Herb of Christina Loosestrife | 16.39% |
| Herb of Virgate Wormwood | 16.39% |
| Chinese Gentian Herb | 16.39% |
| Root of Baikal Skullcap | 4.92% |
| Root tuber of Aromatic Herb | 4.92% |
| Root of Chinese Thorowax | 8.196% |
| Spores of Japanese Climbing Fern | 6.39% |
| Costusroot | 4.92% |
| Rhizome of Figwortflower Picrorhiza | 8.196% |
| Bank of officinal Magnolia | 3.28% |
| Total | 100% |

A₁₆ Edema formula label

| | |
|---|---|
| Herb of Christina Loosestrife | 21.74% |
| Herb of Oriental Waterplantain | 21.74% |
| Common Knotgrass | 17.39% |
| Rhizome of Largehead Atractylodes | 21.74% |
| Plantain Seed | 17.39% |
| Total | 100% |

A₁₇ Fraumatic injury formula label

| | |
|---|---|
| Radix Notoginseng | 24.39% |
| Root of Dahurian Angelica | 14.63% |
| Chinese Angelica | 19.51% |
| Rhizome of Szechwan Lovage | 14.63% |
| Safflower | 12.2% |
| Rhizoma Corydalis | 14.63% |
| Total | 100% |

A₁₈ Hemorrhoid formula label

| | |
|---|---|
| Copis Root | 1.54% |
| Pod of Japanese Pagodatree | 17.22% |
| Root of Baikal Skullcap | 1.566% |
| Radix Notoginseng | 3.76% |
| Root of Garden Burnet | 6.263% |
| Smoked Plum | 3.131% |
| Chinese Angelica | 29.75% |
| Root of Divaricate Saposhnikovia | 0.78% |
| Bitter Orange | 3.131% |
| Fruit of Medicine Terminalia | 3.131% |
| Pomegranate Rind | 29.77% |
| Total | 100% |

A₁₉ Hepatitis formula label

| | |
|---|---|
| Root of Chinese Thorowax | 16.61% |
| Herb of Virgate Wormwood | 16.61% |
| Madras Grangea | 11.13% |
| Herb of Heartleaf Houttuynia | 11.13% |
| Rhizome of Giant Knotweed | 11.13% |
| Dandelion | 11.13% |
| Herb of Christina Lossestrife | 11.13% |
| Chinese Gentian Herb | 11.13% |
| Total | 100% |

A₂₀ Hypertension formula label

| | |
|---|---|
| Fruit spike of Common Selfheal | 13.29% |
| Root of Lobed Kudzuvine | 13.29% |
| Root of Twotooth Achyranthes | 13.29% |
| Gambirplant | 13.29% |
| Adhesive Rehmannia | 6.64% |
| Herb of Common Lophantherum | 13.29% |
| Jointfir | 0.335% |
| Herb of Colored Mistoletoe | 13.29% |
| Root of Baikal Skullcap | 13.29% |
| Total | 100% |

A₂₁ Diarrhea formula label

| | |
|---|---|
| Hexb of Common Andrographis | 33.3% |
| Root of Lightyellow Sophora | 16.7% |
| Costusroot | 8.33% |
| Howthorn Fruit | 4.7% |
| Ringed Dichanthium | 8.33% |
| Root of Chinese Pulsatilla | 16.7% |
| Total | 100% |

A₂₂ Pain formula label

| | |
|---|---|
| Rhizoma Corydalis | 68.11% |
| Root of Dahurian Angelica | 31.89% |
| Total | 100% |

A₂₃ Nehhritis formula label

| | |
|---|---|
| Fruit of Cherokee Rose | 12.31% |
| Dodder Seed | 8.197% |
| Rhizome of Lalang Grass | 7.38% |
| Herb of Yerbadetajo | 7.38% |
| Herb of Heartleaf Houttuynia | 2.31% |
| Fruit of Glossy Privet | 7.38% |
| Lotus Stamen | 4.93% |
| Fruit of Belvedere | 17.94% |
| Rhizome of Oriental Water-plantain | 4.93% |
| Plantain Herb | 4.93% |
| Motherwort Herb | 12.31% |
| Total | 100% |

A₂₄ Dyspepsia formula label

| | |
|---|---|
| Rhizome of Common Yam | 9.542% |
| Rhizome of Largehead Atractylodes | 9.542% |
| Rhizome of Oriental Waterplantain | 9.542% |
| Jujude | 20% |
| Chinese Angelica | 4.8% |
| Membrane of Chicken Gizzard | 9.542% |
| Root of Tuber Fleeceflower | 9.542% |
| Dried Longan Pulp | 9.542% |
| Immature Bitter Orange | 2.86% |
| Areca Seed | 4.8% |
| Howthorn Fruit | 9.542% |
| Total | 100% |

A₂₅ Clinmacteric syndrome formula label

| | |
|---|---|
| Motherwort Herb | 17.94% |
| Root of Baikal Skullcap | 2.87% |
| Rhizome of Nutgrass Galingale | 6.10% |
| Chinese Angelica | 6.10% |
| Root of Fourleaf Ladybell | 6.10% |
| Root of Combined Spicebush | 6.10% |
| Rhizome of Largehead Atractylodes | 6.10% |
| Adhesive Rehmannia | 6.10% |
| Root of Tuber Fleeceflower | 6.46% |
| Root of Twotooth Achyranthes | 6.10% |
| Fruit of Lobed Kudzuvine | 6.10% |
| Root-bark of Chinese Worfberry | 6.10% |
| Wood of Chinese Wolfberry | 0.610% |
| Rhizome of Szechwan Lovage | 6.10% |
| Costusroot | 2.87% |
| Dodder Seed | 6.46% |
| Liquorice Root | 1.794% |
| Total | 100% |

A₂₆ Headache formula label

| | |
|---|---|
| Root of Lobed Kudzuvine | 100% |
| Total | 100% |

A₂₇ Osteoporosis formula label

| | |
|---|---|
| Rhizome of Fortune's Drynaria | 25% |
| Herb of Shorthorned Epimedium | 12.5% |
| Eucommia Bark | 7.5% |
| Bone Bark | 2.5% |
| Rhizome of Szechwan Lovage | 6.25% |
| Radix Notoginseng | 5% |
| Aculeate Staff-tree | 10% |
| Chinese Angelica | 6.25% |
| Root of Himalayan Teasel | 12.5% |
| Root of Mongolian Milkvetch | 12.5% |
| Total | 100% |

A₂₈ Obesity formula label

| | |
|---|---|
| Leaf of Dogbane | 12.82% |
| Rhizome of Oriental Waterkplantain | 10.26% |
| Lotus Leaf | 10.26% |
| Vegetable Sponge of Luffa | 10.26% |
| Rhizome of Szechwan Lovage | 10.26% |
| Howthorm Fruit | 10.26% |
| Pokeberry Root | 5.13% |
| Root of Fourstamen Stephania | 10.26% |
| Read Rhizome | 10.26% |
| Herb of Longtube Ground Ivy | 10.26% |
| Total | 100% |

A₂₉ Hyperplasia of mammary glands formula label

| | |
|---|---|
| Dandelion | 14.6% |
| Spine of Chinese Honeylocust | 9.73% |
| Radix Salviae Miltiorrhizae | 14.6% |
| Radix Notoginseng | 7.08% |
| Safflower | 5.31% |
| Figwort Root | 9.73% |
| Seed of Cowherb | 9.73% |
| Stem of Suberect Spatholobus | 14.6% |
| Root of Uniflower Swisscentaury | 14.6% |
| Total | 100% |

A₃₀ Cough formula label

| | |
|---|---|
| Tangerine Peel | 13.17% |
| Root of Baikal Skullacap | 13.17% |
| Bark of Chinese Corktree | 13.17% |
| Root of Sessile Stemona | 9.88% |
| Jack in the Pulpit Tuber | 4.53% |
| Perilla Seed | 6.584% |
| Root of Whiteflower Hogfennel | 2.4% |
| Apricot Kernel | 6.584% |
| Ephedra | 6.584% |
| Platycodon Root | 6.584% |
| Root-bark of White Mulberry | 6.584% |
| Liquorice Root | 6.584% |
| Total | 100% |

A₃₁ Stomach pain formula label

| | |
|---|---|
| Root of Chinese Thorowax | 15.87% |
| Root of Coastal Gehnia | 4.76% |
| Zedoray | 4.76% |
| Liquorice Root | 9.523% |
| Rhizome of Nutgrass Galingale | 4.76% |
| Costusroot | 12.7% |
| Root of Baikal Skullcap | 15.87% |
| Root of Shinyleaf Pricklyash | 15.87% |
| Rhizoma Corydalis | 15.87% |
| Total | 100% |

A₃₂ Menalgia formula label

| | |
|---|---|
| Chinese Angelica | 10.81% |
| Radix Salviae Miltiorrhizae | 8.11% |
| Prepared Rhizome of Adhesive Rehmannia | 10.81% |
| Rhizoma Corydalis | 16.22% |
| Safflower | 5.41% |
| Motherwort Herb | 32.43% |
| Rhizome of Szechwan Lovage | 4.054% |
| Cassia Bark | 1.351% |
| Costusroot | 1.351% |
| Rhizome of Nutgrass Galingale | 8.11% |
| Dried Ginger | 1.351% |
| Total | 100% |

A₃₃ Prostatic hyperplasia formula label

| | |
|---|---|
| Herb of Chinese Siphonostegia | 50% |
| Lotus Stamen | 50% |
| Total | 100% |

A₃₄ Haryngitis formula label

| | |
|---|---|
| Root of Baikal Skullcap | 12% |
| Capsule of Weeping Forsythia | 20% |
| Flower of Indian Dendranthema | 15% |
| Buffalo Horn | 10% |
| Spine of Chinese Honeylocust | 4.5% |
| Rhubarb | 4.5% |
| Herb of Fineleaf Schizonepeta | 15% |
| Figwort Root | 15% |
| Wesps Nest | 4% |
| Total | 100% |

A₃₅ Hyperosteogeny formula label

| | |
|---|---|
| Safflower | 4.504% |
| Root of Doubleteeth Pubscent Angelica | 9.01% |
| Root of Twotooth Achyranthes | 7.21% |
| Root of Dahurian Angelica | 5.41% |
| Root of Lobed Kudzuvine | 7.21% |
| Rhizome of Fortune's Drynaria | 7.21% |
| Chinese Angelica | 5.41% |
| Rhizome of Szechwan Lovage | 7.21% |
| Root of Divaricate Saposhnikovia | 7.21% |
| Root of Largeleaf Gentian | 7.21% |
| Rhizoma Corydalis | 9.01% |
| Root of Himalayan Teasel | 7.21% |
| Herb of Shorthorned Epimedium | 9.01% |
| Root of Chinese Clematis | 7.21% |
| Total | 100% |

A₃₆ Rhinitis formula label

| | |
|---|---|
| Fruit of Siberian Cocklebur | 23.9% |
| Flower of Indian Dendranthema | 9.514% |
| Herb of Small Centipeda | 14.3% |
| Root of Dahurian Angelica | 7.15% |
| Liquorice Root | 4.79% |
| Fruit of Puncturesine Caltrop | 14.3% |
| Root of Divaricate Saposhnikovia | 7.15% |
| Herb of Yerbadetajo | 14.3% |
| Arisaema with Bile | 4.6% |
| Total | 100% |

A₃₇ Sequela of apoplexy formula label

| | |
|---|---|
| Rhizome of Grassleaf Sweetflag | 25% |
| Red Peony Root | 17% |
| Earth-worm | 17% |
| Radix Codonopsis | 25% |
| Leech | 17% |
| Total | 100% |

A₃₈ Presenility formula label

| | |
|---|---|
| Radix Codonopsis | 23.05% |
| Root of Mongolian Milkvetch | 7.2% |
| Rhizome of Largehead Atractylodes | 3.63% |
| Root of Twotooth Achyranthes | 7.191% |
| Fruit of Chinese Magnoliavine | 2.86% |
| Eucommia Bark | 3.63% |
| Adhesive Rehmannia | 4.3% |
| Chinese Angelica | 4.55% |
| Rhizome of Szechwan Lovage | 3.63% |
| Root of Divaricate Saposhnikovia | 3.63% |
| Tuber of Dwarf Liliturf | 3.63% |
| Rhizome or root of Incised Notopterygium | 2.86% |
| Herb of Shorthorned Epimedium | 7.2% |
| Cassia Bark | 2.86% |
| Fruit of Barbary Wolfberry | 3.63% |
| Prepared Rhizome of Adhesive Rehmannia | 5.38% |
| Tangerine Peel | 3.63% |
| Root of Tuber Fleece flower | 7.2% |
| Total | 100% |

A₃₉ Low grade fever formula label

| | |
|---|---|
| Rhizome of Common Anemarrhena | 6.9% |
| Bark of Chinese Corktree | 6.9% |
| Prepared Rhizome of Adhesive Rehmannia | 27.6% |
| Fruit of Asiatic Cornelian Cherry | 13.8% |
| Tree Peony Bark | 10.34% |
| Root-bark of Chinese Wolfberry | 13.8% |
| Rhizome of Oriental Waterplantain | 10.34% |
| Fruit of Chinese Magnoliavine | 10.34% |
| Total | 100% |

A₄₀ Carbuncle and sore formula label

| | |
|---|---|
| Capsule of Weeping Forsythia | 15.2% |
| Figwort Root | 15.2% |
| Coptis Root | 1.27% |
| Adhesive Rehmannia | 12.7% |
| Root of Baikal Skullcap | 15.2% |
| Achene of Great Burdock | 12.7% |
| Red Peony Root | 12.7% |
| Rhizome of Common Anemarrhena | 10.13% |
| Concentrated Powder from Buffalo Horn | 5.06% |
| Total | 100% |

B₁ Pangent warm diaphoretic formula label

| | |
|---|---|
| Ephedra | 20% |
| Cassia Twig | 27% |
| Root of Divaricate Saposhnikovia | 33% |
| Liquorice Root | 20% |
| Total | 100% |

B₂ Pungent cool diaphoresis formula label

| | |
|---|---|
| Herb of Wild Mint | 19% |
| Mulberry Leaf | 31% |
| Chrysanthemum | 25% |
| Capsule of Weeping Forsythia | 25% |
| Total | 100% |

B₃ Clearing away heat and purging pathogenic fire formula label

| | |
|---|---|
| Rhizome of Common Anemarrhena | 23.5% |
| Fruit-spike of Common Selfheal | 29.5% |
| Reed Rhizome | 23.5% |
| Ringed Dichanthium | 23.5% |
| Total | 100% |

B₄ Inducing diuresis and resolving heat formula label

| | |
|---|---|
| Rhizome of Lalang Grass | 31% |
| Rhizome of Swordlike A | 25% |
| Bark of Chinese Corktree | 25% |
| Root of Twotooth | 19% |
| Total | 100% |

B₅ Clearing away the heat and cooling the blood formula label

| | |
|---|---|
| Dried Rhizome of Rehmannia | 31% |
| Red Peony Root | 19% |
| Tree Peony Bark | 25% |
| Radix Salviae Miltiorrhizae | 25% |
| Total | 100% |

B₆ Clearing away the heat and toxic materials formula label

| | |
|---|---|
| Coplis Root | 21.5% |
| Bark of Chinese Corktree | 21.5% |
| Fruit of Cape Jasmine | 21.5% |
| Root of Baikal Skullcap | 35.5% |
| Total | 100% |

B₇ Nourishing yin and clearing away the fire formula label

| | |
|---|---|
| Startwort Root | 24% |
| Root-bark of Chinese Wolfberry | 24% |
| Rhizome of Common Anemarrhena | 24% |
| Herb of Sweet Wormwood | 28% |
| Total | 100% |

B₈ Promoting digestion and resolving stagnation formula label

| | |
|---|---|
| Howthorn Fruit | 21.5% |
| Radish Seed | 35.5% |
| Membrane of Chicken Gizzard | 21.5% |
| Bark of Officinal Magnolia | 21.5% |
| Total | 100% |

B₉ Expelling wind to regulate meridian formula label

| | |
|---|---|
| Radix Salviae Miltiorrhizae | 19% |
| Root of Fourstamen Stephania | 19% |
| Root of Largeleaf Gentian | 19% |
| Root of Divaricate Saposhnikovia | 23.1% |
| Stem of Suberect Spatholobus | 19% |
| Total | 100% |

B₁₀ Clearing away summer heat and excreting damp formula label

| | |
|---|---|
| Rhizome of Swordlike Atractylodes | 45.5% |
| Herb of Wrinkled Gianthyssop | 27% |
| Herb of Fortune Eupatorium | 27% |
| Total | 100% |

B₁₁ Regulating qi to promote diuresis formula label

| | |
|---|---|
| Rhizome of Oriental Waterplantain | 31% |
| Plantain Seed | 25% |
| Rhizome of Largehead Atractylodes | 25% |
| Cassia Twig | 19% |
| Total | 100% |

B₁₂ Warming middle-heater to eliminate damp formula label

| | |
|---|---|
| Dried Ginger | 33% |
| Rhigome of Largehead Atractylodes | 27% |
| Fruit of Medicinal Evodia | 20% |
| Liquorice Root | 20% |
| Total | 100% |

B₁₃ Regulating qi and invigorating the distending formula label

| | |
|---|---|
| Costusroot | 33% |
| Rhizome of Nutgrass Galingale | 27% |
| Bark of Officinal Magnolia | 20% |
| Liquorice Root | 20% |
| Total | 100% |

B₁₄ Promoting circulation of gi and blood formula label

| | |
|---|---|
| Root-tuber of Aromatic Turmeric | 25% |
| Radix Salviae Miltiorrhizae | 31% |
| Rhizoma Corydalis | 25% |
| Fruit of Szechwan Chinaberry | 19% |
| Total | 100% |

B₁₅ Activating blood and climinating the sedimentation formula label

| | |
|---|---|
| Rhizome of Szechwan Lovage | 20% |
| Radix Salviae Miltiorrhizae | 33% |
| Safflower | 20% |
| Rhizoma Corydalis | 27% |
| Total | 100% |

B₁₆ Purging phlem heat formula label

| | |
|---|---|
| Fritillary | 30% |
| Tuber of Pinellia | 23% |
| Root of Baikal Skullcap | 30% |
| Rhizome of Common Anemarrhena | 17% |
| Total | 100% |

B₁₇ Clearting the liver and enriching the spleen formula label

| | |
|---|---|
| Root of Chinese Thorowax | 25% |
| Costusroot | 25% |
| Rhizome of Nutgrass Galingale | 31% |
| Rhizome of Szechwan Lovage | 19% |
| Total | 100% |

B₁₈ Promoting digestion and cathasis formula label

| | |
|---|---|
| Ginseng | 25% |
| Root of Mongolian Milkvetch | 31% |
| Rhizome of Largehead Atractylodes | 25% |
| Root of Chinese Thorowax | 19% |
| Total | 100% |

B₁₉ Warming kidney to activate yang formula label

| | |
|---|---|
| Herb of Shorthorned Epimedium | 33% |
| Desertliving Cistanche | 20% |
| Rhizome of Common Curculigo | 20% |
| Root of Medicinal Indian Mulberry | 27% |
| Total | 100% |

B₂₀ Tonifying qi and blood formula label

| | |
|---|---|
| Chinese Angelice | 28% |
| Root of Tuber Fleeceflower | 22% |
| Root of Mongolian Milkvetch | 28% |
| Ginseng | 22% |
| Total | 100% |

B₂₁ Stimuting circulation to end stasis formula label

| | |
|---|---|
| Upright Ladybell | 30% |
| Tuber of Dwarf Lilyturf | 23% |
| Rhizome of Fragrant Solomonseal | 17% |
| Rhizome of Siberian Solomonseal | 30% |
| Total | 100% |

B₂₂ Restraining the hyperactivity of the liver-yang formula label

| | |
|---|---|
| Gambirplant | 33% |
| Tuber of Tall Gastrodia | 20% |
| Fruit-spike of Common Selfheal | 27% |
| Chrysanthemum | 20% |
| Total | 100% |

B₂₃ Nourishing yin and preserving one's health formula label

| | |
|---|---|
| Radix Codonopsis | 25% |
| Seed of Spine Date | 25% |
| Radix Salviae Miltiorrhizae | 31% |
| Root of Thinleaf Milkwort | 19% |
| Total | 100% |

B₂₄ Invigorating the liver and kidney formula label

| | |
|---|---|
| Prepared Rhizome of Adhesive Rehmannia | 33% |
| Pulp of Asiatic Cornelian Cherry | 20% |
| Fruit of Barbary Wolfberry | 20% |
| Chinese Angelica | 27% |
| Total | 100% |

B₂₅ Strengthening the spleen and tonifying the kidney formula label

| | |
|---|---|
| Ginseng | 22% |
| Root of Mongolian Milkvetch | 28% |
| Rhizome of Largehead Atractylodes | 22% |
| Herb of Shorthomed Epimedium | 28% |
| Total | 100% |

B₂₆ Drying damp and eliminating phlegm formula label

| | |
|---|---|
| Tuber of Pinellia | 25% |
| Fritillary | 25% |
| Tangerine Peel | 19% |
| Root of Sessile Stemona | 31% |
| Total | 100% |

B₂₇ Clearing liver and benefiting gallbladder formula label

| | |
|---|---|
| Chinese Gentian Herb | 33% |
| Root of Chinese Thorowax | 20% |
| Root of Baikal Skullcap | 27% |
| Fruit of Cape Jasmine | 20% |
| Total | 100% |

B₂₈ Nourishing yin and purging fire formula label

| | |
|---|---|
| Rhizome of Common Anemarrhena | 31% |
| Bark of Chinese Corktree | 25% |
| Herb of Sweet Wormwood | 25% |
| Tree Peony Bark | 19% |
| Total | 100% |

B₂₉ Dispelling coldness regulate the meridians formula label

| | |
|---|---|
| Stem of Suberect Spatholobus | 30% |
| Cassia Twig | 17% |
| Radix Salviae Miltiorrhizae | 30% |
| Tree Peony Bark | 23% |
| Total | 100% |

B₃₀ Promoting digestion and resolving stagnation formula label

| | |
|---|---|
| Chinese Angelica | 31% |
| Dried Rhizome of Rehmannia | 25% |
| Hemp Seed | 25% |
| Senna Leaf | 19% |
| Total | 100% |

### DETAILED DESCRIPTION OF THE INVENTION

1. “A network hospital is made as per all individual diseases, on which one can choose corresponding commercial way for combined diet invigorating substances.” Includes configuration of e-business Website of network hospital, page layout of browser, joining the membership, downloading the health consult software of network doctor to the terminal computer free of charge, upgrading the software free of charge, downloading credit card, remote registration of website, usage of health diagnoses database software of network hospital, confirmation of diseases, confirmation of type of individual cases and principle of cure, glancing over commodities, confirmation of commodities and putting them into shopping vehicle, issuing order of goods, settlement and payment via credit card, transport, usage of commodities and feedback of information. The patent of commercial method also includes: overall view of network hospital, which is made as per all individual diseases and one can choose corresponding commercial way for combined diet invigorating substances (Table 1), health consult software of network doctor, disease, symptom, category, principle of cure, suggested structure of number and its dictionary (Table 3), numbering structure of health diagnosis software of network hospital (Table 4), corresponding recipe of health invigorating substances for 40 diseases (Table 5) and corresponding recipe of health invigorating substances for 30 diseases of different category (Table 6).

2. The patent is used in the application frame of e-commerce, taking the intelligent medicine specialty technology as the structure unit of main system. In the patent, the basic network configuration is utilized to provide a platform for the e-commerce and intelligent medicine specialty technology, one can downloads and uses a large quantity of health consult software of network doctor free of charge to make services without limit of geographic region, to realize direct transaction and to fully develop the market potential of direct e-commerce. In addition, one also can utilizes the database software of network hospital to complete indirect e-commerce with the help of external delivery and transport after the transaction of goods via e-commerce is accomplished. The intelligent integration is realized of e-commerce application program. In the course of solution via e-commerce, e-commerce, coordination, intelligence of business, management of knowledge and intelligent specialty technology are integrated into one to realize the purchase mode of User to online and the integrated mode of application program. It realizes the innovation of commercial method to combine indirect e-commerce with direct e-commerce.

3. Characterized by the excellent combination of the intelligent specialty technology of American medicine with the intelligent commercial transaction, the patent provides the services of mail, community, upgrading and downloading of software free of charge, linking up network, listing, safety, printing, database, configuration and transactions for medicine specialty technology health consult software of intelligent network doctor, health diagnosis software of network hospital and the intelligent transaction of e-commerce through the application programs of Internet, server, router and browser.

4. Except for the server software development of conventional e-commerce application program and supporting the application program logics of e-commerce, the patent takes intelligent network doctor software of medicine specialty technology and the software of network hospital as core function. One can use them without limit, download them free of charge and continuously upgrade health consult software of network doctor, which are the means to increase the market share. Customers can download the software of network doctor via the application program in customer frame of Internet's browser into the database of his or her terminal computer or into the memory of server and use them as you like.

5. The following is as example to carry out commercial deal in the patent: Entering the website and opening homepage. Glancing over page layout, signing agreement, joining the membership to get the number of membership. Entering the number of membership to download the health software of network doctor into your terminal computer. Entering website and number of membership to remotely register website. Confirmation of disease A₂ on the menu and confirmation of A₂ commodity. Opening the homepage of disease, symptom, category and principle of cure. Click A_{2 Click b}₂, c₂ and k₂ l₂. Glancing over B₃, B₁₄ and conformation of B₃ and B₁₄ commodities. Putting A₂, B₃ and B₁₄ commodities into shopping vehicle. Delivering order, settlement and payment. Receipt of commodities, usage of them and feedback of information.

1. I claim that “a network hospital is made as per all individual diseases, on which one can choose corresponding commercial way for combined diet invigorating substances.” is my invention:
I acknowledge that my invention includes configuration of e-business Website of network hospital, page layout of browser, joining the membership, downloading the health consult software of network doctor to the terminal computer free of charge, upgrading the software free of charge, downloading credit card, remote registration of website, usage of health diagnosis database software of network hospital, confirmation of diseases, confirmation of type of individual cases and principle of cure, glancing over commodities, confirmation of commodities and putting them into shopping vehicle, issuing order of goods, settlement and payment via credit card, transport, usage of commodities and feedback of information.
I also acknowledge that the invention includes: overall view of network hospital, which is made as per all individual diseases and one can choose corresponding commercial way for combined diet invigorating substances ( Table 1), health consult software of network doctor, disease, symptom, category, principle of cure, suggested structure of number and its dictionary (Table 3), numbering structure of health diagnosis software of network hospital (Table 4), corresponding recipe of health invigorating substances for 40 diseases (Table 5) and corresponding recipe of health invigorating substances for 30 diseases of different category (Table 6).
I acknowledge that my invention takes intelligent network doctor software of medicine specialty technology and the software of network hospital as core function. One can use them without limit, download them free of charge and continuously upgrade health consult software of network doctor, which are the means to increase the market share. Customers can download the software of network doctor via the application program in customer frame of Internet's browser into the database of his or her terminal computer or into the memory of server and use them as you like.
